(19) United States
(12) Patent Application Publication
(10) Pub. No.: US 2024/0317262 A1
(43) Pub. Date: Sep. 26, 2024

(54) INTEGRATED INSPECTION TOOLS FOR AUTONOMOUS VEHICLE NETWORKS

(71) Applicant: TuSimple, Inc., San Diego, CA (US)

(72) Inventors: Joyce TAM, Pleasanton, CA (US); Janet Karen HWU, San Diego, CA (US); Shaheryar AJMAL, La Jolla, CA (US)

(73) Assignee: TuSimple, Inc., San Diego, CA (US)

(21) Appl. No.: 18/438,191

(22) Filed: Feb. 9, 2024

Related U.S. Application Data
(60) Provisional application No. 63/491,090, filed on Mar. 20, 2023.

(51) Int. Cl. B60W 60/00

(52) U.S. Cl. CPC B60W 60/0015; B60W 60/0025

(57) ABSTRACT

A method, apparatus and computer program product are configured to generate, based on a user profile, one or more dynamic inspection task checklists for a respective autonomous vehicle (AV) of one or more AVs in an AV fleet based on a first enterprise-defined task protocol. The one or more dynamic inspection task checklists are associated with one or more respective AV subsystems, and the user profile is associated with a respective user role such that the one or more dynamic inspection task checklists differ dependent upon the respective user role. The method, apparatus and computer program product are also configured to cause the one or more dynamic inspection task checklists to be rendered via an interactive inspection interface of a user computing device associated with the user profile such that one or more respective inspection tasks comprised in the one or more dynamic inspection task checklists are interactive.

### CROSS-REFERENCE TO RELATED APPLICATION

The present application claims priority to U.S. Provisional Patent Application No. 63/491,090, filed Mar. 20, 2023, the contents of which are incorporated herein by reference in their entirety.

### TECHNICAL FIELD

The present disclosure relates generally to autonomous vehicles (AVs). More particularly, the present disclosure is related to an AV inspection system employed to inspect various subsystem components associated with AVs.

### BACKGROUND

One aim of autonomous vehicle technologies is to provide vehicles that can safely navigate towards a destination with limited or no driver assistance. The effective navigation of an autonomous vehicle (AV) from one location to another may include the ability to signal other vehicles, navigating around other vehicles in shoulders or emergency lanes, changing lanes, biasing appropriately in a lane, and navigating all portions or types of highway lanes. Autonomous vehicle technologies may enable an AV to operate without requiring extensive learning or training by nearby drivers proximate the AV, by ensuring that the AV can operate effectively, in a way that is evident, logical, or familiar to nearby drivers and pedestrians.

In order for an enterprise to operate a fleet of AVs in an autonomous vehicle network, the AVs must be able to operate effectively amongst other vehicles that are traveling on public roadways. Furthermore, any AV operating in an autonomous vehicle network by way of public roadways must comply with various safety standards and regulations including federal, state and/or local safety standards and regulations (hereinafter collectively and individually referenced as safety standards and regulations). As such, for an AV to remain in compliance with the safety standards and regulations, documentation must be provided describing the condition of one or more AV subsystems related to the AV. It follows that in order to document that each of the component parts related to one or more respective AV subsystems associated with an AV are functioning correctly, each of the component parts must be inspected and/or tested before the AV departs for a predetermined destination.

### BRIEF SUMMARY

In general, embodiments of the present disclosure provide methods, apparatus, systems, computing devices, computing entities, and/or the like for performing in-depth inspections of one or more autonomous vehicles (AVs) associated with an AV fleet related to a particular enterprise operating within an autonomous vehicle network. For example, certain embodiments of the present disclosure utilize systems, methods, and computer program products for inspecting one or more AVs in order to certify that the one or more AVs are capable of operating in an autonomous driving mode on public streets and highways while remaining in compliance with the safety standards and regulations.

In accordance with one aspect, an apparatus comprising at least one processor and at least one non-transitory memory including computer program code instructions is provided. The computer program code instructions are configured to, when executed, cause the apparatus to: generate, based on a user profile, one or more dynamic inspection task checklists for a respective autonomous vehicle (AV) of one or more AVs in an AV fleet based on a first enterprise-defined task protocol. The one or more dynamic inspection task checklists are associated with one or more respective AV subsystems, and the user profile is associated with a respective user role such that the one or more dynamic inspection task checklists differ dependent upon the respective user role. The computer program code instructions are also configured to cause the one or more dynamic inspection task checklists to be rendered via an interactive inspection interface of a user computing device associated with the user profile such that one or more respective inspection tasks comprised in the one or more dynamic inspection task checklists are interactive.

The user role associated with the user profile can be at least one of a maintenance role, an inspection role, an operator role, a client role, an administrative role, a regulatory role, or a law enforcement role, and the one or more dynamic inspection checklists may be configured based in part on the user role associated with the user profile.

The apparatus of an example embodiment further includes computer program code instructions configured to cause the apparatus to, upon completion of the one or more dynamic inspection task checklists, generate one or more interactive post-inspection reports. The one or more interactive post-inspection reports are configured based in part on the user role associated with the user profile, and the one or more interactive post-inspection reports describes the passing or failure of the one or more respective AV subsystems associated with the respective AV of the one or more AVs.

The apparatus of an example embodiment further includes computer program code instructions configured to generate, based on the one or more interactive post-inspection reports, one or more respective post-inspection audit reports. The one or more post-inspection audit reports describe compliance of the respective AV to one or more vehicle safety and regulatory standards.

The apparatus of an example embodiment further includes computer program code instructions configured to, upon successful completion of the one or more dynamic inspection task checklists, transmit a signoff request to an operation server. The signoff request is associated with the respective AV of the one or more AVs. The computer program code instructions are also configured to, in response to receiving a signoff approval signal associated with the signoff request, certify that the respective AV is capable of transitioning into an autonomous driving mode. The computer program code instructions are also configured to deploy the respective AV to a next destination. The data related to the next destination is comprised within mission data associated with the AV.

The one or more dynamic inspection task checklists may be generated based in part on one or more portions of AV fleet data. The one or more portions of AV fleet data comprise data related to at least one of AV mission data, AV location data, AV identification data, AV logistics data, AV payload data, AV health data, or AV safety compliance data.

In another aspect, a computer-implemented method includes generating, based on a user profile, one or more dynamic inspection task checklists for a respective autonomous vehicle (AV) of one or more AVs in an AV fleet based on a first enterprise-defined task protocol. The one or more dynamic inspection task checklists are associated with one or more respective AV subsystems, and the user profile is associated with a respective user role such that the one or more dynamic inspection task checklists differ dependent upon the respective user role. The computer-implemented method also includes causing the one or more dynamic inspection task checklists to be rendered via an interactive inspection interface of a user computing device associated with the user profile such that one or more respective inspection tasks comprised in the one or more dynamic inspection task checklists are interactive.

The user role associated with the user profile can be at least one of a maintenance role, an inspection role, an operator role, a client role, an administrative role, a regulatory role, or a law enforcement role, and the one or more dynamic inspection checklists may be configured based in part on the user role associated with the user profile.

The computer-implemented method of an example embodiment further includes, upon completion of the one or more dynamic inspection task checklists, generating one or more interactive post-inspection reports. The one or more interactive post-inspection reports are configured based in part on the user role associated with the user profile, and the one or more interactive post-inspection reports describes the passing or failure of the one or more respective AV subsystems associated with the respective AV of the one or more AVs.

The computer-implemented method of an example embodiment further includes generating, based on the one or more interactive post-inspection reports, one or more respective post-inspection audit reports, where the one or more post-inspection audit reports describe compliance of the respective AV to one or more vehicle safety and regulatory standards.

The computer-implemented method of an example embodiment further includes upon successful completion of the one or more dynamic inspection task checklists, transmitting a signoff request to an operation server. The signoff request is associated with the respective AV of the one or more AVs. The computer-implemented method also includes, in response to receiving a signoff approval signal associated with the signoff request, certifying that the respective AV is capable of transitioning into an autonomous driving mode. The computer-implemented method also includes deploying the respective AV to a next destination, where data related to the next destination is comprised within mission data associated with the AV.

The one or more dynamic inspection task checklists may be generated based in part on one or more portions of AV fleet data, and the one or more portions of AV fleet data comprises data related to at least one of AV mission data, AV location data, AV identification data, AV logistics data, AV payload data, AV health data, or AV safety compliance data.

In another aspect, a computer program product comprising at least one non-transitory computer-readable storage medium having computer-executable program code instructions stored therein is provided. The computer-executable program code instructions comprise program code instructions configured to generate, based on a user profile, one or more dynamic inspection task checklists for a respective autonomous vehicle (AV) of one or more AVs in an AV fleet based on a first enterprise-defined task protocol. The one or more dynamic inspection task checklists are associated with one or more respective AV subsystems, and the user profile is associated with a respective user role such that the one or more dynamic inspection task checklists differ dependent upon the respective user role. The program code instructions are also configured to cause the one or more dynamic inspection task checklists to be rendered via an interactive inspection interface of a user computing device associated with the user profile such that one or more respective inspection tasks comprised in the one or more dynamic inspection task checklists are interactive.

The user role associated with the user profile can be at least one of a maintenance role, an inspection role, an operator role, a client role, an administrative role, a regulatory role, or a law enforcement role, and the one or more dynamic inspection checklists may be configured based in part on the user role associated with the user profile.

The computer program product of an example embodiment further includes program code instructions configured to, upon completion of the one or more dynamic inspection task checklists, generate one or more interactive post-inspection reports. The one or more interactive post-inspection reports are configured based in part on the user role associated with the user profile, and the one or more interactive post-inspection reports describes the passing or failure of the one or more respective AV subsystems associated with the respective AV of the one or more AVs.

The computer program product of an example embodiment further includes program code instructions configured to generate, based on the one or more interactive post-inspection reports, one or more respective post-inspection audit reports. The one or more post-inspection audit reports describe compliance of the respective AV to one or more vehicle safety and regulatory standards.

The computer program product of an example embodiment further includes program code instructions configured to upon successful completion of the one or more dynamic inspection task checklists, transmit a signoff request to an operation server. The signoff request is associated with the respective AV of the one or more AVs The computer program product also includes program code instructions configured to, in response to receiving a signoff approval signal associated with the signoff request, certify that the respective AV is capable of transitioning into an autonomous driving mode. The computer program product also includes program code instructions configured to deploy the respective AV to a next destination, where data related to the next destination is comprised within mission data associated with the AV.

The one or more dynamic inspection task checklists may be generated based in part on one or more portions of AV fleet data. The one or more portions of AV fleet data comprises data related to at least one of AV mission data, AV location data, AV identification data, AV logistics data, AV payload data, AV health data, or AV safety compliance data.

In another aspect, an apparatus comprising at least one processor and at least one non-transitory memory including computer program code instructions is provided. The computer program code instructions are configured to, when executed, cause the apparatus to generate one or more dynamic inspection task checklists for a respective autonomous vehicle (AV) of one or more AVs in an AV fleet based on a first enterprise-defined task protocol. The one or more dynamic inspection task checklists are associated with one or more respective AV subsystems. The apparatus also includes computer program code instructions configured to cause the one or more dynamic inspection task checklists to be rendered via an interactive inspection interface such that one or more respective inspection tasks comprised in the one or more dynamic inspection task checklists are interactive. The apparatus also includes computer program code instructions configured to initiate, based on information provided by the interactive inspection interface, an automated self-check protocol associated with the respective AV. Initializing the automated self-check protocol causes an in-vehicle control computer associated with the respective AV to execute one or more automated diagnostic procedures to ensure nominal function of one or more respective components of the one or more AV subsystems. The apparatus also includes computer program code instructions configured to determine, based in part on the automated self-check protocol, whether the respective AV is certified to transition into an autonomous driving mode. The apparatus also includes computer program code instructions configured to, in response to determining that the respective AV is certified to transition into the autonomous driving mode, deploy the respective AV to a next destination, where the next destination is determined based in part on the AV fleet data.

The first enterprise-defined task protocol may be based on a first configuration of inspection task data objects corresponding to one or more respective inspection tasks associated with the one or more AV subsystems.

The apparatus of an example embodiment further includes computer program code instructions configured to generate one or more dynamic inspection task checklists for one or more respective AVs based on a second enterprise-defined task protocol. The second enterprise-defined task protocol is based on a second configuration of inspection task data objects corresponding to one or more respective inspection tasks associated with the one or more AV subsystems.

The apparatus of an example embodiment further includes computer program code instructions configured to generate, based on at least one completed dynamic inspection task checklist of the one or more dynamic inspection task checklists, one or more interactive post-inspection reports. The one or more interactive post-inspection reports describes the passing or failure of the one or more respective AV subsystems associated with the respective AV.

The apparatus of an example embodiment further includes computer program code instructions configured to generate, based on the one or more interactive post-inspection reports, one or more post-inspection audit reports associated with the respective AV. The one or more post-inspection audit reports describe compliance of the respective AV to one or more vehicle safety and regulatory standards.

The apparatus of an example embodiment further includes computer program code instructions configured to, in response to determining the respective AV is not certified to transition into the autonomous driving mode, transmit, to the operational server system, a suspension signal associated with the respective AV. The suspension signal comprises an indication of one or more critical failures associated with the one or more respective AV subsystems. The apparatus also includes computer program code instructions configured to transmit, to the in-vehicle control computer associated with the respective AV, a hard-stop command such that the respective AV can no longer operate in the autonomous driving mode until the one or more critical failures have been corrected.

The apparatus of an example embodiment further includes computer program code instructions configured to capture image data associated with the one or more respective inspection tasks comprised in the one or more dynamic inspection task checklists.

The one or more dynamic inspection task checklists may be generated based in part on one or more portions of AV fleet data. The one or more portions of AV fleet data may comprise data related to at least one of AV mission data, AV location data, AV identification data, AV logistics data, AV payload data, AV health data, or AV safety compliance data.

In another aspect, a computer-implemented method includes generating one or more dynamic inspection task checklists for a respective autonomous vehicle (AV) of one or more AVs in an AV fleet based on a first enterprise-defined task protocol. The one or more dynamic inspection task checklists are associated with one or more respective AV subsystems. The computer-implemented method also includes causing the one or more dynamic inspection task checklists to be rendered via an interactive inspection interface such that one or more respective inspection tasks comprised in the one or more dynamic inspection task checklists are interactive. The computer-implemented method also includes initiating, based on information provided by the interactive inspection interface, an automated self-check protocol associated with the respective AV. Initializing the automated self-check protocol causes an in-vehicle control computer associated with the respective AV to execute one or more automated diagnostic procedures to ensure nominal function of one or more respective components of the one or more AV subsystems. The computer-implemented method also includes determining, based in part on the automated self-check protocol, whether the respective AV is certified to transition into an autonomous driving mode. The computer-implemented method also includes, in response to determining that the respective AV is certified to transition into the autonomous driving mode, deploying the respective AV to a next destination, where the next destination is determined based in part on the AV fleet data.

The first enterprise-defined task protocol may be based on a first configuration of inspection task data objects corresponding to one or more respective inspection tasks associated with the one or more AV subsystems.

The computer-implemented method of an example embodiment further includes generating one or more dynamic inspection task checklists for one or more respective AVs based on a second enterprise-defined task protocol. The second enterprise-defined task protocol is based on a second configuration of inspection task data objects corresponding to one or more respective inspection tasks associated with the one or more AV subsystems.

The computer-implemented method of an example embodiment further includes generating, based on at least one completed dynamic inspection task checklist of the one or more dynamic inspection task checklists, one or more interactive post-inspection reports. The one or more interactive post-inspection reports describes the passing or failure of the one or more respective AV subsystems associated with the respective AV.

The computer-implemented method of an example embodiment further includes generating, based on the one or more interactive post-inspection reports, one or more post-inspection audit reports associated with the respective AV. The one or more post-inspection audit reports describe compliance of the respective AV to one or more vehicle safety and regulatory standards.

The computer-implemented method of an example embodiment further includes, in response to determining the respective AV is not certified to transition into the autonomous driving mode, transmitting, to the operational server system, a suspension signal associated with the respective AV. The suspension signal comprises an indication of one or more critical failures associated with the one or more respective AV subsystems. The computer-implemented method further includes transmitting, to the in-vehicle control computer associated with the respective AV, a hard-stop command such that the respective AV can no longer operate in the autonomous driving mode until the one or more critical failures have been corrected.

The computer-implemented method further includes capturing image data associated with the one or more respective inspection tasks comprised in the one or more dynamic inspection task checklists.

The one or more dynamic inspection task checklists may be generated based in part on one or more portions of AV fleet data. The one or more portions of AV fleet data may comprise data related to at least one of AV mission data, AV location data, AV identification data, AV logistics data, AV payload data, AV health data, or AV safety compliance data.

In another aspect, a computer program product comprising at least one non-transitory computer-readable storage medium having computer-executable program code instructions stored therein is provided. The computer-executable program code instructions comprise program code instructions configured to generate one or more dynamic inspection task checklists for a respective autonomous vehicle (AV) of one or more AVs in an AV fleet based on a first enterprise-defined task protocol. The one or more dynamic inspection task checklists are associated with one or more respective AV subsystems. The computer program product also includes program code instructions configured to cause the one or more dynamic inspection task checklists to be rendered via an interactive inspection interface such that one or more respective inspection tasks comprised in the one or more dynamic inspection task checklists are interactive. The computer program product also includes program code instructions configured to initiate, based on information provided by the interactive inspection interface, an automated self-check protocol associated with the respective AV. Initializing the automated self-check protocol causes an in-vehicle control computer associated with the respective AV to execute one or more automated diagnostic procedures to ensure nominal function of one or more respective components of the one or more AV subsystems. The computer program product also includes program code instructions configured to determine, based in part on the automated self-check protocol, whether the respective AV is certified to transition into an autonomous driving mode. The computer program product also includes program code instructions configured to, in response to determining that the respective AV is certified to transition into the autonomous driving mode, deploy the respective AV to a next destination, where the next destination is determined based in part on the AV fleet data.

The first enterprise-defined task protocol may be based on a first configuration of inspection task data objects corresponding to one or more respective inspection tasks associated with the one or more AV subsystems.

The computer program product of an example embodiment further includes program code instructions configured to generate one or more dynamic inspection task checklists for one or more respective AVs based on a second enterprise-defined task protocol. The second enterprise-defined task protocol is based on a second configuration of inspection task data objects corresponding to one or more respective inspection tasks associated with the one or more AV subsystems.

The computer program product of an example embodiment further includes program code instructions configured to generate, based on at least one completed dynamic inspection task checklist of the one or more dynamic inspection task checklists, one or more interactive post-inspection reports. The one or more interactive post-inspection reports describes the passing or failure of the one or more respective AV subsystems associated with the respective AV.

The computer program product of an example embodiment further includes program code instructions configured to generate, based on the one or more interactive post-inspection reports, one or more post-inspection audit reports associated with the respective AV. The one or more post-inspection audit reports describe compliance of the respective AV to one or more vehicle safety and regulatory standards.

The computer program product of an example embodiment further includes program code instructions configured to, in response to determining the respective AV is not certified to transition into the autonomous driving mode, transmit, to the operational server system, a suspension signal associated with the respective AV. The suspension signal comprises an indication of one or more critical failures associated with the one or more respective AV subsystems. The computer program product also includes program code instructions configured to transmit, to the in-vehicle control computer associated with the respective AV, a hard-stop command such that the respective AV can no longer operate in the autonomous driving mode until the one or more critical failures have been corrected.

The computer program product of an example embodiment further includes program code instructions configured to capture image data associated with the one or more respective inspection tasks comprised in the one or more dynamic inspection task checklists.

The one or more dynamic inspection task checklists may be generated based in part on one or more portions of AV fleet data. The one or more portions of AV fleet data comprise data related to at least one of AV mission data, AV location data, AV identification data, AV logistics data, AV payload data, AV health data, or AV safety compliance data.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example communication system that can be used to practice embodiments of the present disclosure;

FIG. 2 illustrates a diagram of an example autonomous vehicle configured to implement autonomous driving operations in accordance with some embodiments discussed herein;

FIG. 3 illustrates a block diagram of an operation server in accordance with some embodiments discussed herein;

FIG. 4 illustrates a block diagram of a control subsystem in accordance with some embodiments discussed herein;

FIG. 5 illustrates a diagram of an in-vehicle control computer included in an autonomous vehicle (AV) in accordance with some embodiments discussed herein;

FIG. 6 illustrates an exemplary user computing device system in accordance with some embodiments discussed herein;

FIG. 7 illustrates an exemplary user computing device in accordance with some embodiments discussed herein;

FIG. 8 illustrates a system that provides an exemplary environment related to AV inspection, in accordance with some embodiments discussed herein;

FIG. 9 illustrates an exemplary system associated with an interactive user interface, in accordance with some embodiments discussed herein;

FIG. 10 is a process flow diagram of an example process generating one or more dynamic inspection task checklists for an AV based on a user profile in accordance with some embodiments discussed herein;

FIG. 11 is a process flow diagram of an example process for performing an AV inspection in accordance with some embodiments discussed herein;

FIG. 12 is an operational example of an AV fleet inspection list in accordance with some embodiments discussed herein;

FIG. 13 is an operational example of a dynamic inspection task checklist associated with an AV in accordance with some embodiments discussed herein;

FIG. 14 is an operational example of an inspection task issue reporting interface in accordance with some embodiments discussed herein;

FIG. 15 is an operational example of a dynamic inspection task checklist associated with an automated self-check protocol related to an AV in accordance with some embodiments discussed herein;

FIG. 16 is an operational example of a plurality of successfully completed dynamic inspection task checklist in accordance with some embodiments discussed herein;

FIG. 17 is an operational example of an interactive post-inspection report in accordance with some embodiments discussed herein;

FIG. 18 is an operational example of an interactive post-inspection report table associated with a plurality of AVs in accordance with some embodiments discussed herein; and

FIG. 19 is an operational example of a post-inspection audit report generated based on an interactive inspection report in accordance with some embodiments discussed herein.

### DETAILED DESCRIPTION

Some embodiments of the present disclosure will now be described more fully hereinafter with reference to the accompanying drawings, in which some, but not all embodiments are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

Enterprises, operators, and/or customers associated with autonomous vehicle networks need to be able to monitor, track, and assist the various mission objectives of one or more autonomous vehicles (AVs) in an AV fleet that is operating on public roadways. Moreover, the enterprises and operators responsible for the AV fleet need to be able to enforce and act upon the various regulatory and safety checklists issued by the governing bodies tasked with keeping the public roadways safe such as, for example, the Federal Motor Carrier Safety Administration (FMCSA).

Embodiments of the present disclosure provide an AV inspection system which can be employed to certify that one or more AVs in an AV fleet are capable of entering into an autonomous driving mode such that the AV can operate unmanned on public streets and highways. In this regard, the AV inspection system is configured to assist in the inspection, diagnosis, and testing of various AV subsystems associated with an AV. For example, the AV inspection system is configured to inspect, diagnose, and test one or more respective components of various control subsystems, vehicle drive subsystems, vehicle sensor subsystems, and/or vehicle control subsystems associated with an AV.

The AV inspection system is configured to receive AV fleet data associated with one or more AVs operating in an autonomous vehicle network. Based on the AV fleet data, the AV inspection system can generate one or more dynamic inspection task checklists associated with one or more respective AV subsystems for one or more particular inbound and/or outbound AVs in a particular AV travel hub. For an enterprise with a large AV fleet, there can be many AV travel hubs located across the country configured to accommodate multiple inbound and/or outbound AVs at any given time. Vehicle inspectors associated with respective vehicle inspector profiles can be located at a respective AV travel hub and employ the AV inspection system to assist with and/or execute various AV inspection tasks associated with one or more AVs in order to certify that the one or more respective AVs are capable of transitioning into an autonomous driving mode.

The AV inspection system offers the technical advantage of allowing an enterprise to determine an enterprise-defined task protocol such that a preferred inspection methodology and/or protocol can be executed by one or more vehicle inspectors. For example, the AV inspection system can generate one or more dynamic inspection task checklists for a particular AV based on a particular enterprise-defined task protocol. The enterprise-defined task protocol can be based on a specific configuration of inspection task data objects that correspond to respective AV inspection tasks associated with one or more AV subsystems. An enterprise can re-define the task protocol by reconfiguring, restructuring, re-sequencing, and/or re-ordering the one or more inspection task data objects and, as a result, the AV inspection system can generate new dynamic inspection task checklists based on the reconfigured enterprise-defined task protocol.

Furthermore, the AV inspection system provides the technical benefit of causing an AV to execute an automated self-check protocol. A user computing device associated with a vehicle inspector profile that is associated with the AV inspection system can direct, via a communications network, an in-vehicle control computer aboard an AV to execute one or more automated diagnostic procedures. The one or more automated diagnostic procedures can cause one or more components associated with one or more respective AV subsystems to automatically execute various self-checks configured to test the operational capacities of the one or more AV subsystem components. An automatic self-check protocol can direct the in-vehicle control computer to cause the one or more AV subsystem components to execute automated diagnostic procedures such as, but not limited to, automatic power cycling of the AV subsystem components, automatic engagement of the AV subsystem components, various stress-tests associated with the AV subsystem components, various network connectivity tests associated with the AV subsystem components, various sensor data collection tests, and/or the like. The AV inspection system can determine whether the AV subsystem components satisfy a respective predetermined performance threshold during the execution of the automated diagnostic procedures and indicate whether the one or more AV subsystem components have passed or failed the self-checks on an interactive inspection interface of a user computing device associated with an inspector profile.

Based in part on the successful completion of a plurality of dynamic inspection task checklists and/or the successful completion of an automated self-check protocol associated with a particular AV, the AV inspection system can determine whether the particular AV is capable of transitioning into an autonomous driving mode such that the AV can operated unmanned on public streets and highways. If an AV is certified to transition into the autonomous driving mode, a user computing device associated with a vehicle inspector profile can deploy the AV to a next destination. For example, a vehicle inspector can issue a deployment command to a particular AV based on an interaction with the interactive inspection interface associated with the AV inspection system such that the in-vehicle control computer associated with the AV assumes control. Once the in-vehicle control computer assumes control of the AV, the in-vehicle control computer can direct the AV to engage various subsystems configured to operate the AV autonomously such that the AV will travel unmanned to a next destination corresponding to a particular mission plan assigned to the AV.

Embodiments of the present disclosure are also configured to generate one or more interactive post-inspection reports summarizing the various dynamic inspection task checklists completed in relation to a particular AV. For example, the AV inspection system can compile and organize an interactive post-inspection report associated with a particular AV and transmit the interactive post-inspection report to the operation server and/or an application server associated with the enterprise responsible for the AV. Additionally, the AV inspection system can generate documentation based on the interactive post-inspection report that describes how the AV is in compliance with various safety standards and regulations. For instance, the AV inspection system can generate one or more post-inspection audit reports based on the interactive post-inspection report. In the event that highway patrol and/or safety personnel need to weigh, inspect, and/or otherwise engage the AV, the post-inspection audit report can provide the necessary documentation needed to demonstrate that the AV is in compliance with relevant safety standards and regulations.

### Example Systems and Apparatuses of the Present Disclosure

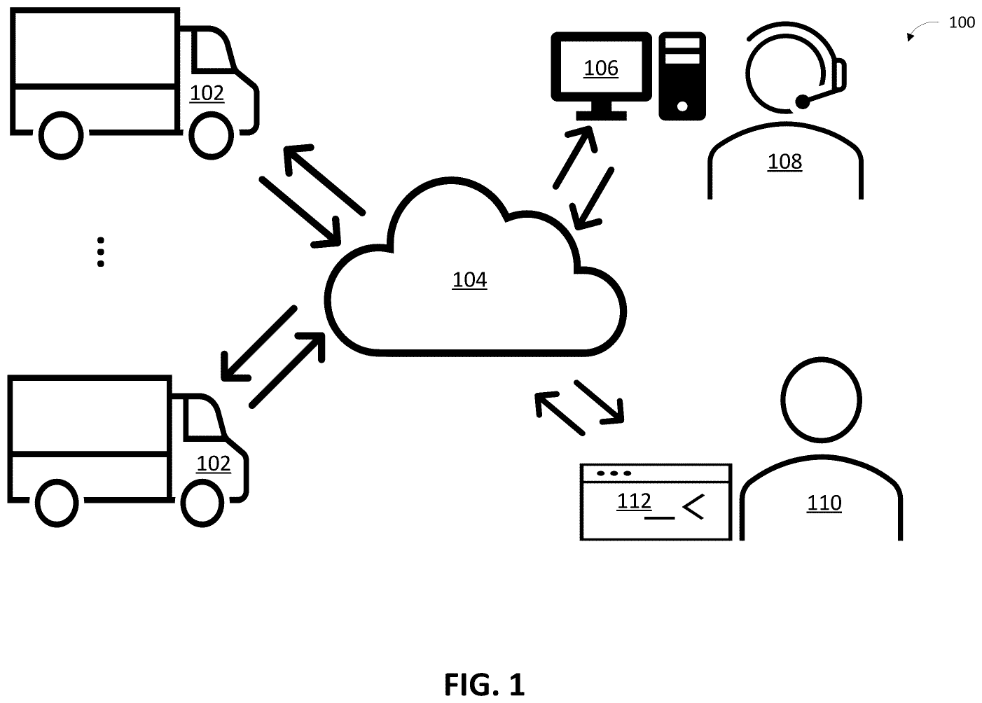

FIG. 1 illustrates an example system 100 that includes one or more AVs 102, an operation server 106 with a human operator 108, and a user interface 112 for third-party 110 interaction. A human operator 108 may also be known as a remoter center operator (RCO). Communications between the AVs 102, operation server 106 and user interface 112 take place over a network 104. In some instances, where not all the AVs 102 in a fleet are able to communicate with the operation server 106, the AVs 102 may communicate with each other over the network 104 or directly. Each AV 102 may include an in-vehicle control computer (VCU) which enables a module for network communications. In some embodiments, an AV 102 may be a semi-truck tractor unit that attaches to a trailer to transport cargo or freight. However, as will be appreciated by one of skill in the art, the AV 102 may be embodied by any autonomous vehicle such as a car, truck, drone, water vessel, and/or the like.

An autonomous vehicle may be in communication with an operation server. The operation server may serve many purposes, including: tracking the progress of one or more autonomous vehicles (e.g., an autonomous truck), tracking the progress of a fleet of autonomous vehicles; sending maneuvering instructions to one or more autonomous vehicles; monitoring the health of the autonomous vehicle(s), monitoring the status of the cargo of each autonomous vehicle in contact with the operation server, facilitate communications between third parties (e.g., law enforcement, clients whose cargo is being carried) and each, or a specific, autonomous vehicle; allow for tracking of specific autonomous trucks in communication with the operation server (e.g., third-party tracking of a subset of vehicles in a fleet), arranging maintenance service for the autonomous vehicles (e.g., oil changing, fueling, maintaining the levels of other fluids), alerting an affected autonomous vehicle of changes in traffic or weather that may adversely impact a route or delivery plan, pushing over the air updates to autonomous trucks to keep all components up to date, and other purposes or functions that improve the safety for the autonomous vehicle, its cargo, and/or its surroundings. An operation server may also determine performance parameters of an autonomous vehicle or autonomous truck, including any of: data logging frequency, compression rate, location, data type; communication prioritization; how frequently to service the autonomous vehicle (e.g., how many miles between services); when to perform a minimal risk condition (MRC) maneuver while monitoring the vehicle's progress during the maneuver; when to hand over control of the autonomous vehicle to a human driver (e.g., at a destination yard); ensuring an autonomous vehicle passes pre-trip inspection; ensuring an autonomous vehicle performs or conforms to legal requirements at checkpoints and weight stations; ensuring an autonomous vehicle performs or conforms to instructions from a human at the site of a roadblock, cross-walk, intersection, construction, or accident; and/or the like.

To allow for communication between autonomous vehicles in a fleet and an operation server or command center, each autonomous vehicle may be equipped with a communication gateway. The communication gateway may have the ability to do any of the following: allow for AV to operation server communication (i.e. V2C) and the operation server to AV communication (C2V); allow for AV to AV communication within the fleet (V2V); transmit the availability or status of the communication gateway; acknowledge received communications; ensure security around remote commands between the AV and the operation server; convey the AV's location reliably at set time intervals; enable the operation server to ping the AV for location and vehicle health status; allow for streaming of various sensor data directly to the command or operation server; allow for automated alerts between the AV and operation server; comply to International Organization for Standardization (ISO) 21434 standards; and the like.

An operation server or command center may be operated by one or more human, also known as an operator and/or a remote center operator. The operator may set thresholds for autonomous vehicle health parameters, so that when an autonomous vehicle meets or exceeds the threshold, precautionary action may be taken. Examples of vehicle health parameters for which thresholds may be established by an operator may include any of: fuel levels; oil levels; miles traveled since last maintenance; low tire-pressure detected; cleaning fluid levels; brake fluid levels; responsiveness of steering and braking subsystems; Diesel exhaust fluid (DEF) level; communication ability (e.g., lack of responsiveness); positioning sensors ability (e.g., GPS, IMU malfunction); impact detection (e.g., vehicle collision); perception sensor ability (e.g., camera, LIDAR, radar, microphone array malfunction); computing resources ability (e.g., VCU or ECU malfunction or lack of responsiveness, temperature abnormalities in computing units); angle between a tractor and trailer in a towing situation (e.g., tractor-trailer, 18-wheeler, or semi-truck); unauthorized access by a living entity (e.g., a person or an animal) to the interior of an autonomous truck; and the like. The precautionary action may include execution of a minimal risk condition (MRC) maneuver, seeking service, or exiting a highway or other such re-routing that may be less taxing on the autonomous vehicle. An autonomous vehicle whose system health data meets or exceeds a threshold set at the operation server or by the operator may receive instructions that are automatically sent from the operation server to perform the precautionary action.

The operator may be made aware of situations affecting one or more autonomous vehicles in communication with or being monitored by the operation server that the affected autonomous vehicle(s) may not be aware of. Such situations may include: irregular or sudden changes in traffic flow (e.g., traffic jam or accident); abrupt weather changes; abrupt changes in visibility; emergency conditions (e.g., fire, sink-hole, bridge failure); power outage affecting signal lights; unexpected road work; large or ambiguous road debris (e.g., object unidentifiable by the autonomous vehicle); law enforcement activity on the roadway (e.g., car chase or road clearing activity); and the like. These types of situations that may not be detectable by an autonomous vehicle may be brought to the attention of the operation server operator through traffic reports, law enforcement communications, data from other vehicles that are in communication with the operation server, reports from drivers of other vehicles in the area, and similar distributed information venues. An autonomous vehicle may not be able to detect such situations because of limitations of sensor systems or lack of access to the information distribution means (e.g., no direct communication with weather agency). An operator at the operation server may push such information to affected autonomous vehicles that are in communication with the operation server. The affected autonomous vehicles may proceed to alter their route, trajectory, or speed in response to the information pushed from the operation server. In some instances, the information received by the operation server may trigger a threshold condition indicating that MRC (minimal risk condition) maneuvers are warranted; alternatively, or additionally, an operator may evaluate a situation and determine that an affected autonomous vehicle should perform an MRC maneuver and subsequently send such instructions to the affected vehicle. In these cases, each autonomous vehicle receiving either information or instructions from the operation server or the operation server operator uses its on-board computing unit (i.e. VCU) to determine how to safely proceed, including performing an MRC maneuver that includes pulling-over or stopping.

An operation server or command center may allow a third party to interact with the operation server operator, with an autonomous truck, or with both the human system operator and an autonomous truck. A third party may be a customer whose goods are being transported, a law enforcement or emergency services provider, or a person assisting the autonomous truck when service is needed. In its interaction with a third party, the operation server may recognize different levels of access, such that a customer concerned about the timing or progress of a shipment may only be allowed to view status updates for an autonomous truck, or may able to view status and provide input regarding what parameters to prioritize (e.g., speed, economy, maintaining originally planned route) to the operation server. By providing input regarding parameter prioritization to the operation server, a customer can influence the route and/or operating parameters of the autonomous truck.

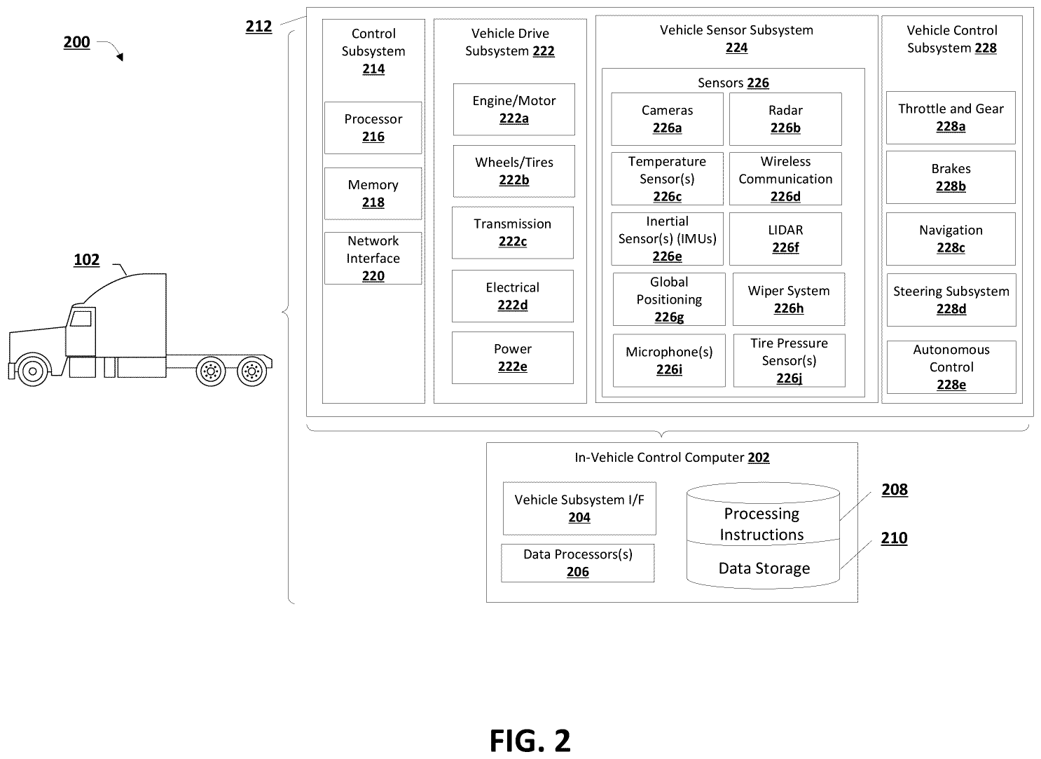

FIG. 2 shows a block diagram of an example vehicle ecosystem 200 in which autonomous driving operations can be determined. As shown in FIG. 2, the AV 102 may be an autonomous semi-trailer truck. The vehicle ecosystem 200 includes several systems and components that can generate and/or deliver one or more sources of information/data and related services to the in-vehicle control computer 202 that may be located in an AV 102. The in-vehicle control computer 202 can be in data communication with a plurality of AV subsystems 212, all of which can be resident in the AV 102. An AV subsystem interface 204 is provided to facilitate data communication between the in-vehicle control computer 202 and the plurality of AV subsystems 212. In some embodiments, the AV subsystem interface 204 can include a controller area network (CAN) controller to communicate with devices in the AV subsystems 212.

The AV 102 may include various AV subsystems 212 that support of the operation of AV 102. The AV subsystems 212 may include the control subsystem 214, a vehicle drive subsystem 222, a vehicle sensor subsystem 224, and/or a vehicle control subsystem 228. The components or devices of the vehicle drive subsystem 222, the vehicle sensor subsystem 224, and the vehicle control subsystem 228 shown in FIG. 2 are examples. The vehicle drive subsystem 222 may include components operable to provide powered motion for the AV 102. In an example embodiment, the vehicle drive subsystem 222 may include an engine/motor 222a, wheels/tires 222b, a transmission 222c, an electrical subsystem 222d, and a power source 222e.

The vehicle sensor subsystem 224 may include a number of sensors 226 configured to sense information about an environment or condition of the AV 102. The vehicle sensor subsystem 224 may include one or more cameras 226a, which may be equipped with microphones, or image capture devices, a radar 226b, one or more temperature sensors 226c, a wireless communication unit 226d (e.g., a cellular communication transceiver), an inertial measurement unit (IMU) 226e, a laser range finder, a LiDAR 226f, a Global Positioning System (GPS) transceiver 226g, a wiper control system 226h, microphones 226i, and/or tire pressure sensor(s) 226j. The vehicle sensor subsystem 224 may also include sensors configured to monitor internal systems of the AV 102 (e.g., an 02 monitor, a fuel gauge, an engine oil temperature, etc.).

The IMU 226e may include any combination of sensors (e.g., accelerometers and gyroscopes) configured to sense position and orientation changes of the AV 102 based at least in part on inertial acceleration. The GPS transceiver 226g may be any sensor configured to estimate a geographic location of the AV 102. For this purpose, the GPS transceiver 226g may include a receiver/transmitter operable to provide information regarding the position of the AV 102 with respect to the Earth. The radar 226b may represent a system that utilizes radio signals to sense objects within the local environment of the AV 102. In some embodiments, in addition to sensing the objects, the radar 226b may additionally be configured to sense the speed and the heading of the objects proximate to the AV 102. The laser range finder or LiDAR 226f may be any sensor configured to sense objects in the environment in which the AV 102 is located using lasers. The cameras 226a may include one or more devices configured to capture a plurality of images of the environment of the AV 102. The cameras 226a may be still image cameras or motion video cameras. In some embodiments, the cameras 226a may be configured with one or more microphones to capture audio data. Additionally or alternatively, one or more microphones 226i may be configured to capture audio data of the environment of the AV 102 and/or pertaining to the AV 102.

The vehicle control subsystem 228 may be configured to control the operation of the AV 102 and its components. Accordingly, the vehicle control subsystem 228 may include various elements such as a throttle and gear 228a, a brake unit 228b, a navigation unit 228c, a steering system 228d, and/or an autonomous control unit 228e. The throttle 228a may be configured to control, for instance, the operating speed of the engine and, in turn, control the speed of the AV 102. The gear 228a may be configured to control the gear selection of the transmission. The brake unit 228b can include any combination of mechanisms configured to decelerate the AV 102. The brake unit 228b can use friction to slow the wheels in a standard manner. The brake unit 228b may include an Anti-lock brake system (ABS) that can prevent the brakes from locking up when the brakes are applied. The navigation unit 228c may be any system configured to determine a driving path or route for the AV 102. The navigation unit 228c may additionally be configured to update the driving path dynamically while the AV 102 is in operation. In some embodiments, the navigation unit 228c may be configured to incorporate data from the GPS transceiver 226g and one or more predetermined maps so as to determine the driving path for the AV 102. The steering system 228d may represent any combination of mechanisms that may be operable to adjust the heading of AV 102 in an autonomous mode or in a driver-controlled mode.

The autonomous control unit 228e may represent a control system configured to identify, evaluate, and avoid or otherwise negotiate potential obstacles or obstructions in the environment of the AV 102. In general, the autonomous control unit 228e may be configured to control the AV 102 for operation without a driver or to provide driver assistance in controlling the AV 102. In some embodiments, the autonomous control unit 228e may be configured to incorporate data from the GPS transceiver 226g, the radar 226b, the LiDAR 226f, the cameras 226a, and/or other AV subsystems 212 to determine the driving path or trajectory for the AV 102.

Many or all of the functions of the AV 102 can be controlled by the in-vehicle control computer 202. The in-vehicle control computer 202 may include at least one data processor 206 (which can include at least one microprocessor) that executes processing instructions 208 stored in a non-transitory computer readable medium, such as the data storage 210 or memory. The in-vehicle control computer 202 may also represent a plurality of computing devices that may serve to control individual components or subsystems of the AV 102 in a distributed fashion. In some embodiments, the data storage 210 may contain processing instructions 208 (e.g., program logic) executable by the data processor 206 to perform various methods and/or functions of the AV 102.

The data storage 210 may contain additional instructions as well, including instructions to transmit data to, receive data from, interact with, or control one or more of the vehicle drive subsystem 222, the vehicle sensor subsystem 224, and the vehicle control subsystem 228. The in-vehicle control computer 202 can be configured to include a data processor 206 and a data storage device 1090. The in-vehicle control computer 202 may control the function of the AV 102 based at least in part on inputs received from various AV subsystems 212 (e.g., the vehicle drive subsystem 222, the vehicle sensor subsystem 224, and the vehicle control subsystem 228).

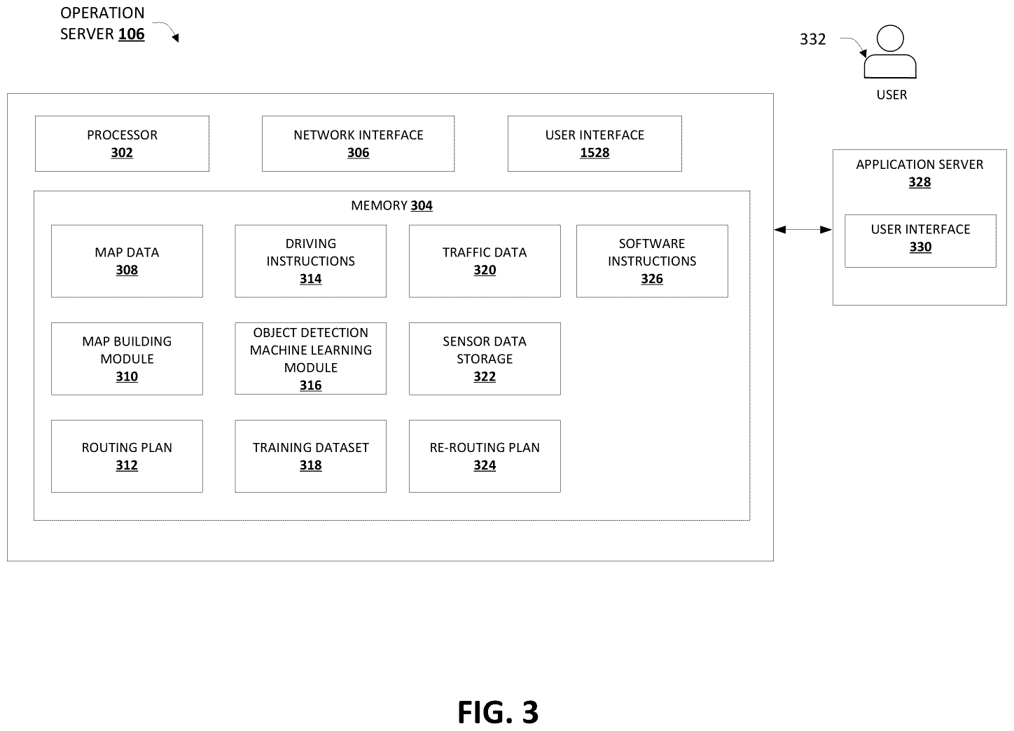

FIG. 3 shows an embodiment of the operation server 106. The operation server 106 includes at least one processor 302, at least one memory 304, and at least one network interface 306. The operation server 106 may be configured as shown or in any other suitable configuration.

The processor 302 comprises one or more processors operably coupled to the memory 304. The processor 302 is any electronic circuitry including, but not limited to, state machines, one or more central processing unit (CPU) chips, logic units, cores (e.g. a multi-core processor), field-programmable gate array (FPGAs), application specific integrated circuits (ASICs), or digital signal processors (DSPs). The processor 302 may be a programmable logic device, a microcontroller, a microprocessor, or any suitable combination of the preceding. The processor 302 is communicatively coupled to and in signal communication with the memory 304, the network interface 306, and user interface 1528. The one or more processors are configured to process data and may be implemented in hardware or software. For example, the processor 302 may be 8-bit, 16-bit, 32-bit, 64-bit or of any other suitable architecture. The processor 302 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processors are configured to implement various instructions. In some embodiments, the function described herein is implemented using logic units, FPGAs, ASICs, DSPs, or any other suitable hardware or electronic circuitry.

The memory 304 is operable to store any of the information described below along with any other data, instructions, logic, rules, or code operable to implement the function(s) described herein when executed by processor 302. For example, the memory 304 may store software instructions 326, map data 308, re-routing plans 324, routing plan 312, training dataset 318, driving instructions 314, sensor data 322 received from the AVs 102, traffic data 320, map building module 310, and/or any other data/instructions. The memory 304 comprises one or more disks, tape drives, or solid-state drives, and may be used as an over-flow data storage device, to store programs when such programs are selected for execution, and to store instructions and data that are read during program execution. The memory 304 may be volatile or non-volatile and may comprise read-only memory (ROM), random-access memory (RAM), ternary content-addressable memory (TCAM), dynamic random-access memory (DRAM), and static random-access memory (SRAM).

The network interface 306 is configured to enable wired and/or wireless communications. The network interface 306 is configured to communicate data between the control subsystem 214 and other network devices, systems, or domain(s). For example, the network interface 306 may comprise a WIFI interface, a local area network (LAN) interface, a wide area network (WAN) interface, a modem, a switch, or a router. The processor 302 is configured to send and receive data using the network interface 306. The network interface 306 may be configured to use any suitable type of communication protocol.

In one embodiment, the operation server 106 may be implemented by a cluster of computing devices that may serve to oversee the operations of the AV 102. For example, the operation server 106 may be implemented by a plurality of computing devices using distributed computing and/or cloud computing systems. In another example, the operation server 106 may be implemented by a plurality of computing devices in one or more data centers. The operation server 106 is in signal communication with the AV 102 and its components (e.g., the in-vehicle control computer 202). In one embodiment, the operation server 106 is configured to determine a particular routing plan 312 for each AV 102. For example, the operation server 106 may determine a particular routing plan 312 for an AV 102 that leads to reduced driving time and a safer driving experience for reaching the destination of that AV 102. In one embodiment, the operation server 106 may capture and record the navigation plans set by the user 332 in each situation and use it in similar situations.

In one embodiment, the operation server 106 may send the sensor data 322 to an application server 328 to be reviewed by users 332. The application server 328 is generally any computing device configured to communicate with other devices, such as other servers (e.g., operation server 106), AV 102, databases, etc., via a network interface. The application server 328 is configured to perform specific functions described herein and interact with users 332, e.g., via its user interfaces 330. Examples of the application server 328 include but are not limited to desktop computers, laptop computers, servers, etc. In one example, the application server 328 may act as a presentation layer where users 332 access to review the sensor data 322. As such, the operation server 106 may send the sensor data 322 to an application server 328. The user 332 may review the sensor data 322 from the user interface 330 and confirm, modify, and/or override navigating solutions for the AVs 102 determined by the control subsystem 214 and/or the operation server 106, such as described above.

Map data 308 may include a virtual map of a city which includes a route. In some examples, the map data 308 may include one or more map databases. The map data 308 may include drivable areas, such as roads, paths, highways, and undrivable areas, such as terrain. The map data 308 may specify location coordinates of road signs, lanes, lane markings, lane boundaries, road boundaries, traffic lights, etc.

The map data 308 may also specify connections between lanes (e.g., which lanes can feed into other adjacent lanes). The map data 308 may specify information indicating types of lanes of a road (e.g., traffic lane, passing lane, emergency lane, turning lane, bus lane, etc.), types of lane boundaries (e.g., white lines, yellow lines, other road surface markings and/or mechanical markings, etc.), types of road boundaries (e.g., regular curbs, red curbs, sidewalks, guard rails, other barriers, etc.), road intersections, one or more obstacles ahead of the autonomous vehicle, and other information about the road or areas adjacent to the road. The map data 308 may also specify elevations of roads, such as curves, hills, valleys; road hazards, such as speed bumps, potholes; road sections, such as road school zones, railroad crossings, etc.

Map building module 310 may be implemented by the processor 302 executing software instructions 326, and configured to build the map data 308. In one embodiment, the map building module 310 may build the map data 308 from sensor data received from one or more mapping vehicles. In one example, a mapping vehicle may be an AV 102. In another example, a mapping vehicle may be an AV 102 or un-autonomous vehicle connected or integrated with sensors 226 operated by a driver. In some cases, one or more mapping vehicles may be dispatched to observe a situation detected by an AV 102, such as via the mandatory and/or auxiliary data transmitted from AV 102 and send more sensor data related to the situation.

The map building module 310 is configured to use the sensor data to determine which portion of the map data 308 they are associated with. The map building module 310 may dynamically build each section of the map data 308 by merging different sensor data associated with each section of the map data 308. The map building module 310 also uses the sensor data to discover overlapping portions of the map data 308 (e.g., by matching corresponding images, videos, LiDAR data, radar data, etc. observing the same portion of the map data 308). The map building module 310 then connects portions of the map data 308 with their corresponding adjacent portions. In other words, the map building module 310 discovers adjacent portions of the map data 308, stitches them together, and builds the map data 308. The map building module 310 is also configured to update a portion of the map data 308 that is based at least in part on the received sensor data that needs to be updated.

For example, in the case of an unknown object in a roadway, when the operation server 106 receives the sensor data from the AV 102 via mandatory data transmission and/or auxiliary data transmission, once it is confirmed that there is indeed an unknown object at particular location coordinates, the map building module 310 updates a portion of the map data 308, reflecting the presence of the unknown object. Similarly, the map building module 310 updates different portions of the map data 308 based at least in part on sensor data related to different cases of encountering unexpected situations.

The map building module 310 is also configured to facilitate shadow testing of routing plans 312 using the new layout of one or more roads in the updated map data 308. For example, when the map data 308 is updated, the map building module 310 may run one or more simulations of autonomous driving through the updates map data 308 for the AV 102. For example, the one or more simulations of autonomous driving may be related to the AV 102 navigating around an object, changing lanes, pulling over, re-routing, etc.

The map building module 310 selects a particular course of autonomous driving from the one or more simulations of autonomous driving that leads to a more efficient, safe, and reliable navigating solution for each AV 102 compared to other simulations.

Routing plan 312 is a plan for traveling from a start location (e.g., a first AV launch pad/landing pad) to a destination (e.g., a second AV launchpad/landing pad). For example, the routing plan 312 of the AV 102 may specify a combination of one or more streets/roads/highways in a specific order from the start location to the destination. The routing plan 312 of the AV 102 may specify stages including the first stage (e.g., moving out from the start location), a plurality of intermediate stages (e.g., traveling along particular lanes of one or more particular street/road/highway), and the last stage (e.g., entering the destination). The routing plan 312 may include other information about the route from the start position to the destination, such as road/traffic signs in that routing plan 312, etc.

The driving instructions 314 may include instructions and rules to adapt the autonomous driving of the AV 102 according to the driving rules of each stage of the routing plan 312. For example, the driving instructions 314 may include instructions to stay within the speed range of a road traveled by the AV 102, adapt the speed of the AV 102 with respect to observed changes by the sensors 226, such as speeds of surrounding vehicles, objects within the detection zones of the sensors, etc.

Object detection machine learning module 316 may be implemented by the processor 302 executing software instructions 326 and is generally configured to detect objects from the sensor data 322. The object detection machine learning module 316 may be implemented using neural networks and/or machine learning algorithms for detecting objects from any data type, such as images, videos, infrared images, point clouds, radar data, etc.

In one embodiment, the object detection machine learning module 316 may be implemented using machine learning algorithms, such as Support Vector Machine (SVM), Naive Bayes, Logistic Regression, k-Nearest Neighbors, Decision trees, or the like. In one embodiment, the object detection machine learning module 316 may utilize a plurality of neural network layers, convolutional neural network layers, and/or the like, in which weights and biases of perceptrons of these layers are optimized in the training process of the object detection machine learning module 316. The object detection machine learning module 316 may be trained by the training dataset 318 which includes samples of data types labeled with one or more objects in each sample. For example, the training dataset 318 may include sample images of objects (e.g., vehicles, lane markings, pedestrian, road signs, etc.) labeled with object(s) in each sample image. Similarly, the training dataset 318 may include samples of other data types, such as videos, infrared images, point clouds, radar data, etc. labeled with object(s) in each sample data. The object detection machine learning module 316 may be trained, tested, and refined by the training dataset 318 and the sensor data 322. The object detection machine learning module 316 uses the sensor data 322 (which are not labeled with objects) to increase their accuracy of predictions in detecting objects. For example, supervised and/or unsupervised machine learning algorithms may be used to validate the predictions of the object detection machine learning module 316 in detecting objects in the sensor data 322.

Traffic data 320 may include traffic data 320 of roads/streets/highways in the map data 308. The operation server 106 may use traffic data 320 gathered by one or more mapping vehicles. The operation server 106 may use traffic data 320 that is captured from any source, such as crowd-sourced traffic data 320 captured from external sources, e.g., Waze and Google map, live traffic reporting, etc.

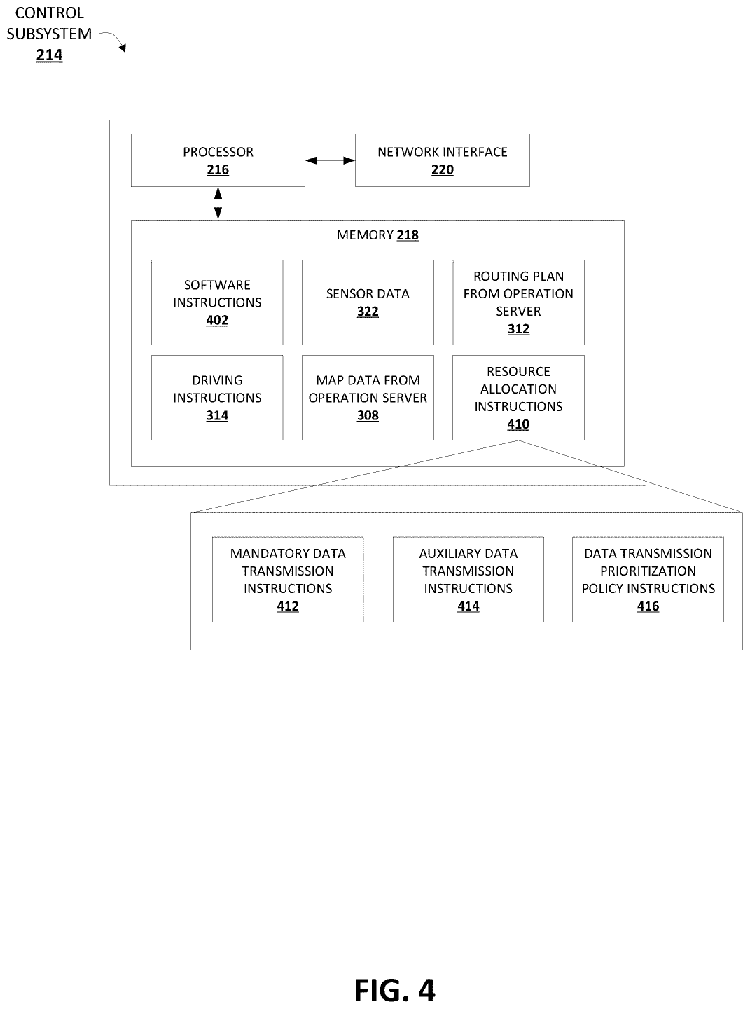

FIG. 4 illustrates an embodiment of the control subsystem 214. The control subsystem 214 includes at least one processor 216, at least one memory 218, and at least one network interface 220. The control subsystem 214 may be configured as shown or in any other suitable configuration.

The processor 216 may comprise one or more processors operably coupled to the memory 218. The processor 216 is any electronic circuitry including, but not limited to, state machines, one or more central processing unit (CPU) chips, logic units, cores (e.g. a multi-core processor), field-programmable gate array (FPGAs), application specific integrated circuits (ASICs), or digital signal processors (DSPs). The processor 216 may be a programmable logic device, a microcontroller, a microprocessor, or any suitable combination of the preceding. The processor 216 is communicatively coupled to and in signal communication with the memory 218 and the network interface 220. The one or more processors are configured to process data and may be implemented in hardware or software. For example, the processor 216 may be 8-bit, 16-bit, 32-bit, 64-bit or of any other suitable architecture. The processor 216 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processors are configured to implement various instructions. In some embodiments, the function described herein is implemented using logic units, FPGAs, ASICs, DSPs, or any other suitable hardware or electronic circuitry.

The memory 218 is operable to store any of the information described below along with any other data, instructions, logic, rules, or code operable to implement the function(s) described herein when executed by processor 216. For example, the memory 218 may store software instructions 402, sensor data 322 received from the sensors 226, vehicle drive subsystem 222, and/or vehicle control subsystem 228 of the AV 102, map data 308, routing plan 312, driving instructions 314, and/or any other data/instructions described herein. The memory 218 may further store resource allocation instructions 410, which may be configured to determine mandatory data transmission instructions 412, auxiliary data transmission instructions 414, data transmission prioritization policy instructions 416. The memory 218 comprises one or more disks, tape drives, or solid-state drives, and may be used as an over-flow data storage device, to store programs when such programs are selected for execution, and to store instructions and data that are read during program execution. The memory 218 may be volatile or non-volatile and may comprise read-only memory (ROM), random-access memory (RAM), ternary content-addressable memory (TCAM), dynamic random-access memory (DRAM), and static random-access memory (SRAM).

The network interface 220 is configured to enable wired and/or wireless communications. The network interface 220 is configured to communicate data between the control subsystem 214 and other network devices, systems, or domain(s). For example, the network interface 220 may comprise a WIFI interface, a local area network (LAN) interface, a wide area network (WAN) interface, a modem, a switch, or a router. The processor 216 is configured to send and receive data using the network interface 220. The network interface 220 may be configured to use any suitable type of communication protocol.

In one embodiment, the control subsystem 214 may be a subsystem of the in-vehicle control computer 202 (See FIG. 2). The control subsystem 214 may be implemented by one or more computing devices that may serve to determine a data transmission prioritization policy and/or control the transmission of mandatory data and/or auxiliary data. The control subsystem 214 is in signal communication with the in-vehicle control computer 202 (and its components) and the operation server 106.

In some embodiments, the mandatory data transmission instructions 412 may be configured to provide instructions regarding the transmission of mandatory data from the AV 102. The instructions may be indicative of which mandatory data to transmit, data pre-processing policy indicative of how mandatory data should be processed prior to being transmitted from the AV 102, a frequency for which the mandatory data is to be transmitted from the AV 102, receiving computing entities (e.g., operation server 106), and/or the like. The mandatory data transmission instructions 412 may be configured to cause a mandatory data object of mandatory data to be transmitted from the AV 102 to one or more computing entities, such as operation server 106.

In some embodiments, the auxiliary data transmission instructions 414 may be configured to provide instructions regarding the transmission of auxiliary data from the AV 102. The instructions may be indicative of which auxiliary data to transmit, data pre-processing policy indicative of how auxiliary data should be processed prior to being transmitted from the AV 102, a frequency for which the auxiliary data is to be transmitted from the AV 102, receiving computing entities (e.g., operation server 106), a measure of auxiliary communication network resource availability, and/or the like. The auxiliary data transmission instructions 414 may be configured to cause an auxiliary data object of auxiliary data to be transmitted from the AV 102 to one or more computing entities, such as operation server 106.

In some embodiments, data transmission prioritization policy instructions 416 may be configured to provide instructions regarding the determination of a data transmission prioritization policy. For example, the data transmission prioritization policy instructions 416 may provide instructions regarding the determination of one or more operational states associated with the AV 102, generation of the data transmission prioritization policy, updating of the transmission prioritization policy, and/or the like. The data transmission prioritization policy may be used by the auxiliary data transmission instructions 414 with regard to the transmission of auxiliary data.

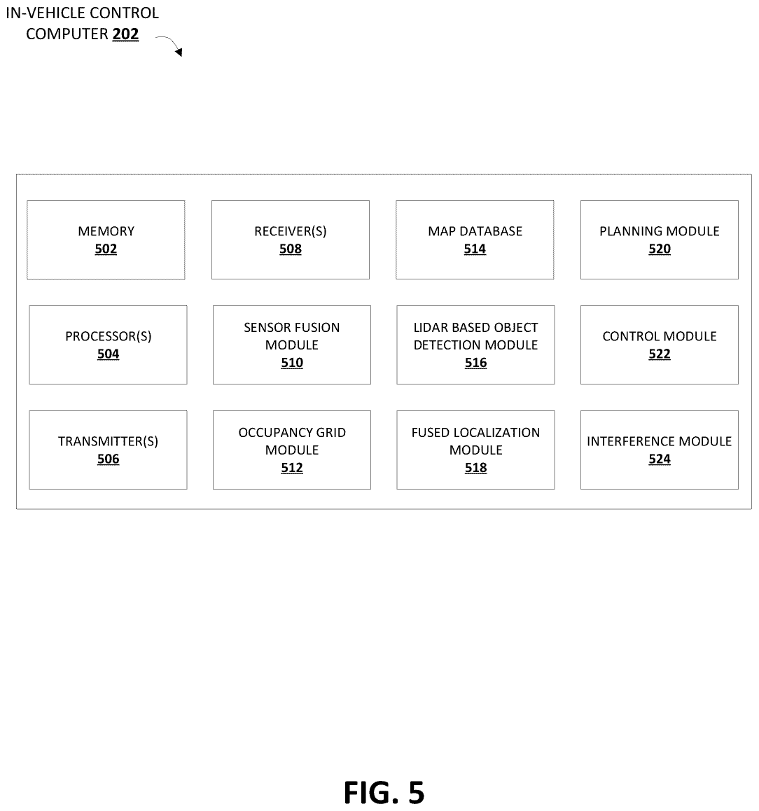

FIG. 5 shows an exemplary block diagram of an in-vehicle control computer 202 included in an AV 102. The in-vehicle control computer 202 includes at least one processor 504 and a memory 502 having instructions stored thereupon (e.g., processing instructions 208 and software instructions 326, 402, and in FIGS. 2, 3, and 4, respectively). The instructions upon execution by the processor 504 configure the in-vehicle control computer 202 and/or the various modules of the in-vehicle control computer 202 to perform the operations described in FIGS. 2-4. The transmitter 506 transmits or sends information or data to one or more devices in the autonomous vehicle. For example, a transmitter 506 can send an instruction to one or more motors of the steering wheel to steer the autonomous vehicle. The receiver 508 receives information or data transmitted or sent by one or more devices. For example, the receiver 508 receives a status of the current speed from the odometer sensor or the current transmission gear from the transmission. The transmitter 506 and receiver 508 are also configured to communicate with the control subsystem 214.

The in-vehicle control computer 202 may include a sensor fusion module 510, which may perform image or signal processing operations. The sensor fusion module 510 can obtain images from cameras located on an autonomous vehicle to perform image segmentation to detect the presence of moving objects (e.g., other vehicles, pedestrians, etc.,) and/or static obstacles (e.g., stop sign, speed bump, terrain, etc.,) located around the autonomous vehicle. The sensor fusion module 510 can obtain LiDAR point cloud data item from LiDAR sensors located on the autonomous vehicle to perform LiDAR segmentation to detect the presence of objects and/or obstacles located around the autonomous vehicle.

The sensor fusion module 510 can perform instance segmentation on image and/or point cloud data item to identify an outline (e.g., boxes) around the objects and/or obstacles located around the autonomous vehicle. The sensor fusion module 510 can perform temporal fusion where objects and/or obstacles from one image and/or one frame of point cloud data item are correlated with or associated with objects and/or obstacles from one or more images or frames subsequently received in time.

The sensor fusion module 510 can fuse the objects and/or obstacles from the images obtained from the camera and/or point cloud data item obtained from the LiDAR sensors. For example, the sensor fusion module 510 may determine based on a location of two cameras that an image from one of the cameras comprising one half of a vehicle located in front of the autonomous vehicle is the same as the vehicle captured by another camera. The sensor fusion module 510 sends the fused object information to the interference module 524 and the fused obstacle information to the occupancy grid module 512. The in-vehicle control computer includes the occupancy grid module 512 that can retrieve landmarks from a map database 514 stored in the in-vehicle control computer. The occupancy grid module 512 can determine drivable areas and/or obstacles from the fused obstacles obtained from the sensor fusion module 510 and the landmarks stored in the map database 514. For example, the occupancy grid module 512 can determine that a drivable area may include a speed bump obstacle.

The in-vehicle control computer 202 may also include a LiDAR based object detection module 516 that can perform object detection based on point cloud data item obtained from the LiDAR sensors located on the AV 102. The object detection technique can provide a location (e.g., in 3D world coordinates) of objects from the point cloud data item. Below the LiDAR based object detection module 516, the in-vehicle control computer may include an image based object detection module that can perform object detection based on images obtained from cameras located on the autonomous vehicle. The object detection technique can employ a deep machine learning technique to provide a location (e.g., in 3D world coordinates) of objects from the image provided by the camera.

The radar on the autonomous vehicle can scan an area in front of the autonomous vehicle or an area towards which the autonomous vehicle is driven. The radar data is sent to the sensor fusion module 510 that can use the radar data to correlate the objects and/or obstacles detected by the radar with the objects and/or obstacles detected from both the LiDAR point cloud data item and the camera image.

The planning module 520 can perform navigation planning to determine a set of trajectories on which the AV 102 can be driven. The set of trajectories can be determined based on the drivable area information, location of the obstacles, and the drivable area information. In some embodiments, the navigation planning may include determining an area next to the road where the autonomous vehicle can be safely parked in case of emergencies. The planning module 520 may include behavioral decision making to determine driving actions (e.g., steering, braking, throttle) in response to determining changing conditions on the road (e.g., traffic light turned yellow, or the autonomous vehicle is in an unsafe driving condition because another vehicle drove in front of the autonomous vehicle and in a region within a pre-determined safe distance of the location of the autonomous vehicle). The planning module 520 performs trajectory generation and selects a trajectory from the set of trajectories determined by the navigation planning operation. The selected trajectory information is sent by the planning module 520 to the control module 522.

The in-vehicle control computer includes a control module 522 that receives the proposed trajectory from the planning module 520 and the autonomous vehicle location and pose from the fused localization module 518. The control module 522 includes a system identifier. The control module 522 can perform a model based trajectory refinement to refine the proposed trajectory. For example, the control module 522 can apply a filter (e.g., Kalman filter) to make the proposed trajectory data smooth and/or to minimize noise. The control module 522 may perform the robust control by determining, based on the refined proposed trajectory information and current location and/or pose of the autonomous vehicle, an amount of brake pressure to apply, a steering angle, a throttle amount to control the speed of the vehicle, and/or a transmission gear. The control module 522 can send the determined brake pressure, steering angle, throttle amount, and/or transmission gear to one or more devices in the autonomous vehicle to control and facilitate precise driving operations of the autonomous vehicle.

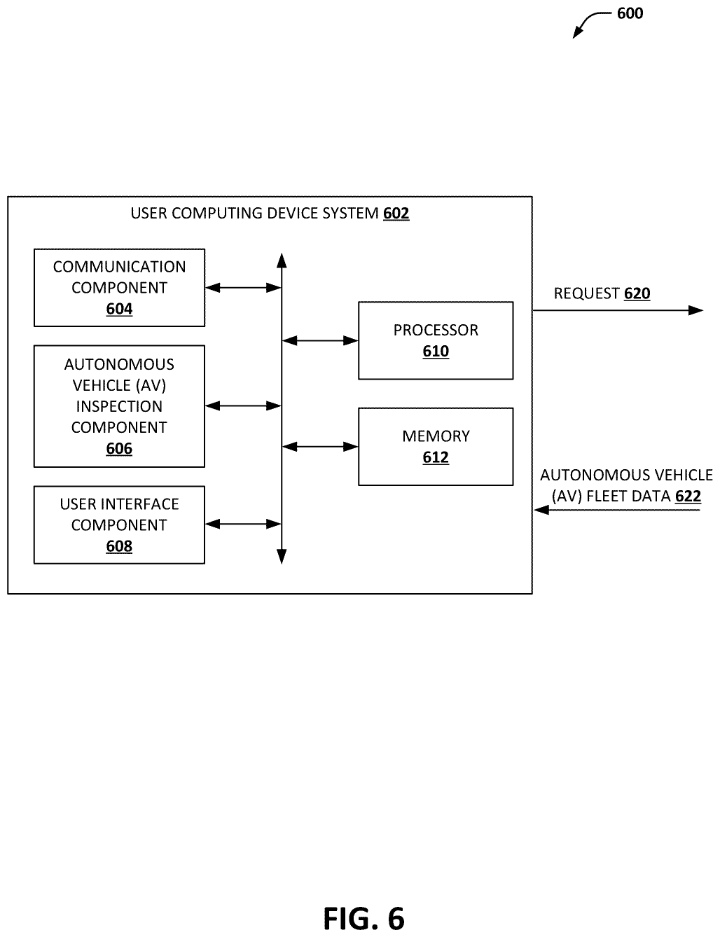

FIG. 6 illustrates a system 600 that provides an exemplary environment according to one or more described features of one or more embodiments of the disclosure. According to an embodiment, the system 600 includes a user computing device system 602 to provide a practical application of autonomous vehicle (AV) inspection for one or more AVs 102 associated with an AV fleet. In various embodiments, the user computing device system 602 provides a practical application of data analytics technology and/or digital transformation technology to facilitate configuration of an interactive inspection interface. In one or more embodiments, the user computing device system 602 provides a practical application of rendering dynamic inspection task checklist data associated with the one or more AVs 102 associated with the AV fleet. In one or more embodiments, the user computing device system 602 employs autonomous vehicle (AV) fleet data 622 that is aggregated from one or more AVs 102 and/or one or more data sources associated with an enterprise system (e.g., a transportation system, a shipping system, a logistics system, and/or another type of enterprise system) to provide real-time insights related to the AV fleet.

In an embodiment, the user computing device system 602 facilitates interaction with an autonomous vehicle network platform associated with an operation server 106, one or more data sources, and/or one or more AVs 102. In one or more embodiments, the user computing device system 602 is a device with one or more processors and a memory. In one or more embodiments, the user computing device system 602 interacts with the operation server 106 to facilitate providing an interactive inspection interface associated with dynamic inspection task checklists related to one or more AVs 102.

In various embodiments, the interactive inspection interface is configured as a dashboard visualization associated with one or more AVs 102 associated with an AV fleet, where the visualization data comprises one or more pieces of data related to, but not limited by, AV identification data, AV subsystem data (e.g., data related to control subsystem 214, vehicle drive subsystem 222, vehicle sensor subsystem 224, vehicle control subsystem 228), AV location data, mission data, AV log data, routing data (e.g., routing plan 312), AV trailer data, AV cargo data, and/or the like. In one or more embodiments, the user computing device system 602 interacts with an in-vehicle control computer 202 associated with a particular AV 102 in order to cause execution of one or more commands by the in-vehicle control computer 202. Additionally, the user computing device system 602 can access data related to the one or more AV subsystems 212 associated with an AV 102 via the in-vehicle control computer 202, the data processor(s) 206, and/or the data storage 210.

The user computing device system 602 includes a communication component 604, an autonomous vehicle (AV) inspection component 606 and/or a user interface component 608. Additionally, in one or more embodiments, the user computing device system 602 includes a processor 610 and/or a memory 612. In certain embodiments, one or more aspects of the user computing device system 602 (and/or other systems, apparatuses and/or processes disclosed herein) constitute executable instructions embodied within a computer-readable storage medium (e.g., the memory 612). For instance, in an embodiment, the memory 612 stores computer executable components and/or executable instructions (e.g., program instructions). Furthermore, the processor 610 facilitates execution of the computer executable components and/or the executable instructions (e.g., the program instructions). In an example embodiment, the processor 610 is configured to execute instructions stored in the memory 612 or otherwise accessible to the processor 610.

The processor 610 is a hardware entity (e.g., physically embodied in circuitry) capable of performing operations according to one or more embodiments of the disclosure. Alternatively, in an embodiment where the processor 610 is embodied as an executor of software instructions, the software instructions configure the processor 610 to perform one or more algorithms and/or operations described herein in response to the software instructions being executed. In an embodiment, the processor 610 is a single core processor, a multi-core processor, multiple processors internal to the user computing device system 602, a remote processor (e.g., a processor implemented on a server), and/or a virtual machine. In certain embodiments, the processor 610 is in communication with the memory 612, the communication component 604, the AV inspection component 606 and/or the user interface component 608 via a bus to, for example, facilitate transmission of data among the processor 610, the memory 612, the communication component 604, the AV inspection component 606 and/or the user interface component 608. The processor 610 may be embodied in a number of different ways and, in certain embodiments, includes one or more processing devices configured to perform independently. Additionally or alternatively, in one or more embodiments, the processor 610 includes one or more processors configured in tandem via a bus to enable independent execution of instructions, pipelining of data, and/or multi-thread execution of instructions.

The memory 612 is non-transitory and includes, for example, one or more volatile memories and/or one or more non-volatile memories. In other words, in one or more embodiments, the memory 612 is an electronic storage device (e.g., a computer-readable storage medium). The memory 612 is configured to store information, data, content, one or more applications, one or more instructions, or the like, to enable the user computing device system 602 to carry out various functions in accordance with one or more embodiments disclosed herein. As used herein in this disclosure, the term “component,” “system,” and the like, is a computer-related entity. For instance, “a component,” “a system,” and the like disclosed herein is either hardware, software, or a combination of hardware and software. As an example, a component is, but is not limited to, a process executed on a processor, a processor, circuitry, an executable component, a thread of instructions, a program, and/or a computer entity.

In one or more embodiments, the communication component 604 is configured to generate a request 620. The request 620 is a request to obtain AV fleet data 622 associated with one or more AVs 102 operating in an AV fleet managed by a particular enterprise associated with an autonomous vehicle network. In various embodiments, the communication component 604 generates the request 620 in response to an action performed with respect to a first user interface configuration for an interactive inspection interface. The action can be, for example, initiating execution of an application (e.g., a mobile application) via a user computing device that presents the interactive inspection interface, altering an interactive graphical element via the interactive inspection interface, or another type of action with respect to the interactive inspection interface. Additionally or alternatively, in one or more embodiments, the communication component 604 generates the request 620 in response to execution of a user authentication process via a user computing device. For example, in an embodiment, the user authentication process is associated with password entry, facial recognition, biometric recognition, security key exchange, and/or another security technique associated with a user computing device.

In various embodiments, the interactive inspection interface is a dashboard visualization related to various AV inspection protocols to be executed in relation to the one or more AVs 102 associated with the AV fleet. In one or more embodiments, the request 620 includes one or more AV identifiers related to the one or more AVs 102 associated with the AV fleet. For example, the one or more AV identifiers can identify and/or tag one or more inbound or outbound AVs 102 in a particular AV travel hub that is scheduled to be inspected by one or more vehicle inspectors. In some embodiments, various AV identifiers can include, but are not limited to, truck IDs, trailer IDs, load IDs, car IDs, SUV IDs, cargo Ids, and/or the like. In various embodiments, one or more AV identifiers can be generated by the operation server 106. In various other embodiments, AV identifiers can be generated by the AV inspection system. In one or more embodiments, one or more AV identifiers can be associated with one or more vehicle identifiers issued by a governing body, such as, for example, the Department of Motor Vehicles (DMV). Such vehicle identifiers can include, but are not limited to, license plate numbers, trailer numbers, vehicle identification numbers (VINs), and/or any other various identifiers associated with an AV 102 that has been issued by a regulatory body.

Additionally or alternatively, in one or more embodiments, the request 620 includes one or more portions of mission data associated with the AV 102, where the mission data comprises, but is not limited to, mission identification data, logistical data comprising arrival and departure locations, arrival and departure times, inspection duration data, down time data (e.g., amount of time stopped at a travel hub for inspection, maintenance, loading, and/or scheduling constraints), and/or the like. Additionally or alternatively, in one or more embodiments, the request 620 includes one or more user identifiers describing a user role for a user profile associated with a user computing device 702 accessing the AV inspection system. A user identifier includes, for example, an identifier for a user profile, where the user profile can be associated with a particular user role. Various user roles can include, but are not limited to, a ground crew member, a vehicle inspector, a maintenance engineer, a supervisor, a manager, a client (whose goods are being transported), a stakeholder, an administrator, an operator, and/or a third-party that might have a reason to interact with an AV 102 and/or the AV inspection system such as a regulatory personnel or law enforcement personnel.

In various embodiments, a user role that is associated with a particular user profile can affect the availability of various permissions, configurations, and/or actions associated with the AV inspection system for the user profile associated with the respective user role. Additionally, the AV inspection system can determine certain configurations and parameters associated with one or more dynamic inspection task checklists related to one or more AVs 102. In certain embodiments, one or more dynamic inspection task checklists are generated based in part on the user role associated with the respective user profile such that different dynamic inspection task checklists are generated for different user roles, thereby providing for the dynamic nature of the inspection task checklists. Additionally, the AV inspection system can generate one or more interactive post-inspection reports based on (and differing depending upon) the user role associated with a respective user profile and, as such, the AV inspection system can generate one or more respective post-inspection audit reports based on the one or more interactive post-inspection reports that were generated based on the user role.

In an embodiment, the communication component 604 is configured to transmit the request 620. In one or more embodiments, the communication component 604 transmits the request 620 to a server system. For example, in one or more embodiments, the communication component 604 transmits the request 620 to an autonomous vehicle (AV) inspection system. In one or more embodiments, the communication component 604 transmits the request 620 via the network 104. In response to the request 620, the communication component 604 and/or the AV inspection component 606 is configured to receive AV fleet data 622. In one or more embodiments, the AV inspection component 606 receives the AV fleet data 622 from the server system. For example, in one or more embodiments, the AV inspection component 606 receives the AV fleet data 622 from an AV inspection system (e.g., AV inspection system 802). In one or more embodiments, the AV inspection component 606 receives the AV fleet data 622 from the operation server 106 and/or the application server 328 to facilitate altering configuration of the interactive inspection interface based on the AV fleet data 622. In one or more embodiments, the communication component 604 and/or the AV inspection component 606 receives the AV fleet data 622 via the network 104. In certain embodiments, the communication component 604 and/or the AV inspection component 606 incorporates encryption capabilities to facilitate encryption and/or decryption of one or more portions of the AV fleet data 622. In one or more embodiments, the network 104 is a Wi-Fi network, a Near Field Communications (NFC) network, a Worldwide Interoperability for Microwave Access (WiMAX) network, a personal area network (PAN), a short-range wireless network (e.g., a Bluetooth® network), an infrared wireless (e.g., IrDA) network, an ultra-wideband (UWB) network, an induction wireless transmission network, and/or another type of network.

In one or more embodiments, the AV fleet data 622 is configured based on the one or more AV identifiers, the one or more portions of mission data, and/or the one or more user identifiers. Additionally, in one or more embodiments, the AV fleet data 622 is configured based on one or more enterprise-defined task protocols, one or more automated self-check protocols, and/or one or more dynamic inspection task checklists associated with the one or more AVs 102 related to the AF fleet. In an embodiment, the AV fleet data 622 comprises prioritized actions (e.g., AV inspection tasks) for the one or more AVs 102 associated with a particular AV fleet. The AV fleet data 622 can comprise prioritized actions related to one or more AVs 102, where the actions are prioritized based on the one or more AV identifiers, the one or more portions of mission data, and/or the one or more user identifiers. For example, the AV fleet data 622 can comprise actions that are prioritized for a particular AV 102 based on one or more portions of respective mission data such as, for example, arrival/departure times, delay times, down time at a particular AV travel hub and/or the like.

The user interface component 608 is configured to render an interactive inspection interface via a display of a user computing device. In one or more embodiments, the interactive inspection interface is configured as a dashboard visualization rendered via a display of a user computing device. In one or more embodiments, the interactive inspection interface is configured to provide dynamic interaction with prioritized AV inspection tasks that are rendered as respective interactive display elements via the interactive inspection interface. An interactive display element is a portion of the interactive inspection interface (e.g., a user-interactive electronic interface portion) that provides interaction with respect to an end user of the user computing device. For example, in one or more embodiments, an interactive display element is an interactive display element associated with a set of pixels that allows a user to provide feedback and/or to perform one or more actions with respect to the interactive inspection interface. Non-limiting examples of interactive display elements can include interactive buttons, hyperlinks, graphs, charts, tables, and/or text input fields.

In an embodiment, in response to interaction with an interactive display element, the interactive inspection interface is dynamically altered to display one or more altered portions of the interactive inspection interface associated with different visual data and/or different interactive display elements. Additionally, in one or more embodiments, the interactive inspection interface is configured to facilitate execution and/or initiation of one or more actions via the dashboard visualization based on the AV fleet data 622. In an embodiment, an action is executed and/or initiated via an interactive display element of the dashboard visualization. In certain embodiments, the interactive inspection interface presents one or more notifications associated with the prioritized actions related to the AV fleet data 622.

In one or more embodiments, the AV inspection component 606 interfaces with the user interface component 608 to alter the first user interface configuration for the interactive inspection interface based on the AV fleet data 622. For example, in one or more embodiments, the AV inspection component 606 alters the first user interface configuration for the interactive inspection interface based on the AV fleet data 622 to provide a second user interface configuration for the interactive inspection interface. Additionally, the user interface component 608 can render the second user interface configuration for the interactive inspection interface via the display of the user computing device. In one or more embodiments, the second user interface configuration includes respective interactive display elements related to the one or more AV inspection tasks, one or more user input fields, and/or one or more portions of mission data. Additionally, in one or more embodiments, the user interface component 608 renders the respective interactive display elements for the second user interface configuration via the interactive inspection interface based on the AV fleet data 622.

Additionally, the user interface component 608 arranges the respective interactive display elements related to the one or more AV inspection tasks associated with one or more dynamic inspection task checklists based on an enterprise-defined task protocol. The enterprise-defined task protocol can be a predetermined sequence and/or ordering of a plurality of AV inspection tasks associated with a respective dynamic inspection task checklist related to a respective AV subsystem. Additionally, the enterprise-defined task protocol can be updated, re-sequenced, and/or re-ordered at any time by way of the user computing device system 602. For example, the user interface component 608 can arrange a plurality of inspection task data objects associated with a respective plurality of AV inspection tasks related to one or more AV subsystems 212. For instance, the user interface component 608 can configure the plurality of inspection task data objects as interactive display elements on the interactive inspection interface such that an end user can manipulate the inspection task data objects, thereby rearranging, re-sequencing, re-ordering, and/or updating the corresponding enterprise-defined task protocol.

In certain embodiments, the user interface component 608 generates one or more interactive display elements comprising a real-time status of updates to the one or more AVs 102. The one or more interactive display elements comprising a real-time status of the one or more AVs 102 can be based on one or more respective portions of mission data. For example, the real-time status of updates can be related to a mission status, a measure of mission progress, a measure of an AV inspection progress, a measure of an AV cargo loading progress, a measure of an AV maintenance progress, and/or the like. Additionally, in response to an interaction with respect to the interactive display elements, the user interface component 608 can alter the second user interface configuration for the interactive inspection interface to provide a third user interface configuration for the interactive inspection interface. The third user interface configuration can provide an ability to capture one or more portions of image and/or video data, one or more portions of audio data, one or more portions of textual data, and/or the like.

In certain embodiments, the user interface component 608 receives an AV inspection task status indicator for one or more AV inspection tasks associated with an AV 102 via the interactive inspection interface. The AV inspection task indicator can indicate whether a particular component of a respective AV subsystem has passed or failed inspection. Additionally or alternatively, the user interface component 608 transmits the AV inspection task status indicator to the server system (e.g., an AV inspection system).

In certain embodiments, the user computing device system 602, by way of the user interface component 608, provides remote control of one or more AVs 102. For example, based on an interaction with the interactive inspection interface, the user computing device system 602 can transmit one or more commands to an in-vehicle control computer 202 associated with a particular AV 102. A non-limiting example of a command that can be issued by the user computing device system 602 includes commands that cause the AV 102 to execute an automated self-check protocol comprising one or more automated diagnostic procedures associated with one or more components of a respective AV subsystem. Additionally, user computing device system 602 can issue a command to deploy an AV 102 to a next destination upon successful completion of one or more dynamic inspection task checklists associated with the AV 102.

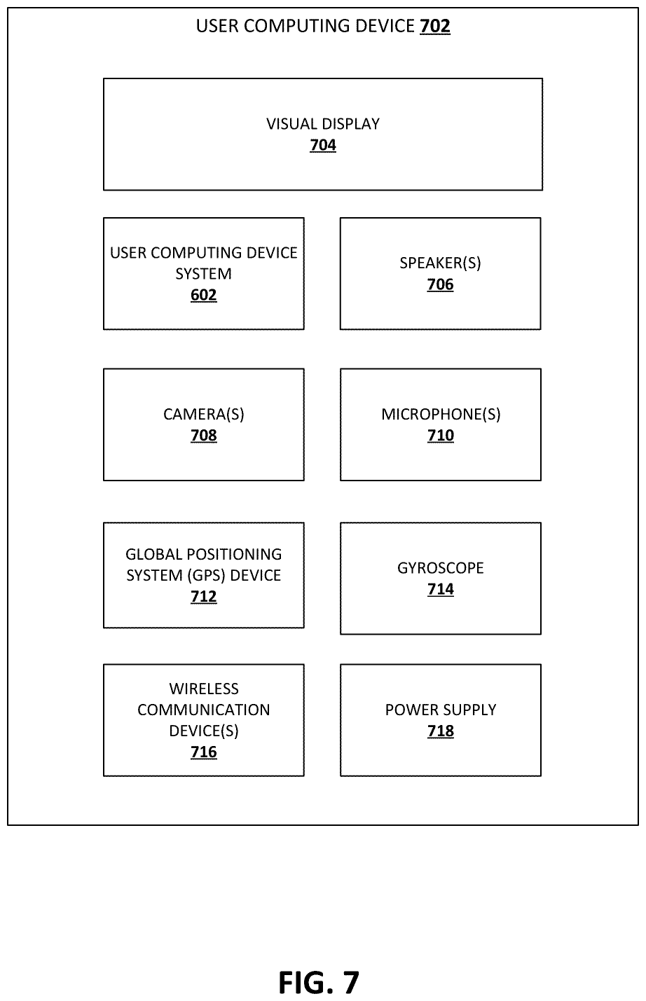

FIG. 7 illustrates an exemplary user computing device in accordance with some embodiments discussed herein. Specifically, FIG. 7 illustrates a system 700 including a user computing device 702. The user computing device 702 can be a mobile computing device, a smartphone, a tablet computer, a mobile computer, a desktop computer, a laptop computer, a workstation computer, a wearable device, a virtual reality device, an augmented reality device, or another type of computing device. In one or more embodiments, the user computing device 702 employs mobile computing, augmented reality, cloud-based computing, IoT technology and/or one or more other technologies to provide performance data, video, audio, text, graphs, charts, real-time data, graphical data, one or more communications, one or more messages, one or more notifications, and/or other media data associated with the dashboard visualization. The user computing device 702 includes mechanical components, electrical components, hardware components and/or software components to facilitate rendering of the dashboard visualization. The user computing device 702 includes the user computing device system 602. In the embodiment shown in FIG. 7, the user computing device 702 also includes a visual display 704, one or more speakers 706, one or more cameras 708, one or more microphones 710, a global positioning system (GPS) device 712, a gyroscope 714, one or more wireless communication devices 716, and/or a power supply 718.

In an embodiment, the visual display 704 is a display that facilitates presentation of and/or interaction with the dashboard visualization associated with the one or more dynamic inspection task checklists generated based in part on AV fleet data 622. In one or more embodiments, the user computing device 702 displays the interactive inspection interface. In one or more embodiments, the visual display 704 is a visual display that renders data associated with the interactive inspection interface. In one or more embodiments, the visual display 704 displays respective interactive display elements associated with the AV fleet data 622. In one or more embodiments, the visual display 704 provides the interactive inspection interface that is configured to allow a user associated with the user computing device 702 to interact with respective user interface configurations of the interactive inspection interface. Additionally, in one or more embodiments, the visual display 704 provides the interactive inspection interface that is configured to allow a user associated with the user computing device 702 to control the one or more interactive display elements associated with one or more AV inspection tasks comprised in the dynamic inspection task checklists. In one or more embodiments, the interactive inspection interface is configured based on user profile data and/or user privileges. In certain embodiments, user specific requirements associated with the interactive inspection interface is configured via a backend system (e.g., an AV inspection system). In one or more embodiments, the interactive inspection interface is configured based on hardware and/or software specifications of the user computing device.

The one or more speakers 706 include one or more integrated speakers that project audio. The one or more cameras 708 include one or more cameras that employ autofocus and/or image stabilization for photo capture and/or real-time video. The one or more microphones 710 include one or more digital microphones that employ active noise cancellation to capture audio data. The GPS device 712 provides a geographic location for the user computing device 702. The gyroscope 714 provides an orientation for the user computing device 702. The one or more wireless communication devices 716 includes one or more hardware components to provide wireless communication via one or more wireless networking technologies and/or one or more short-wavelength wireless technologies. The power supply 718 is, for example, a power supply and/or a rechargeable battery that provides power to the visual display 704, the one or more speakers 706, the one or more cameras 708, the one or more microphones 710, the GPS device 712, the gyroscope 714, and/or the one or more wireless communication devices 716. In certain embodiments, the AV fleet data 622 associated with the prioritized actions is presented via the visual display 704 and/or the one or more speakers 706. In certain embodiments, the visual display 704, the one or more cameras 708, the one or more microphones 710, and/or the GPS device 712 facilitate the user authentication process. In certain embodiments, one or more portions of the one or more wireless communication devices 716 are configured via the communication component 604 to facilitate transmission of the request 620.

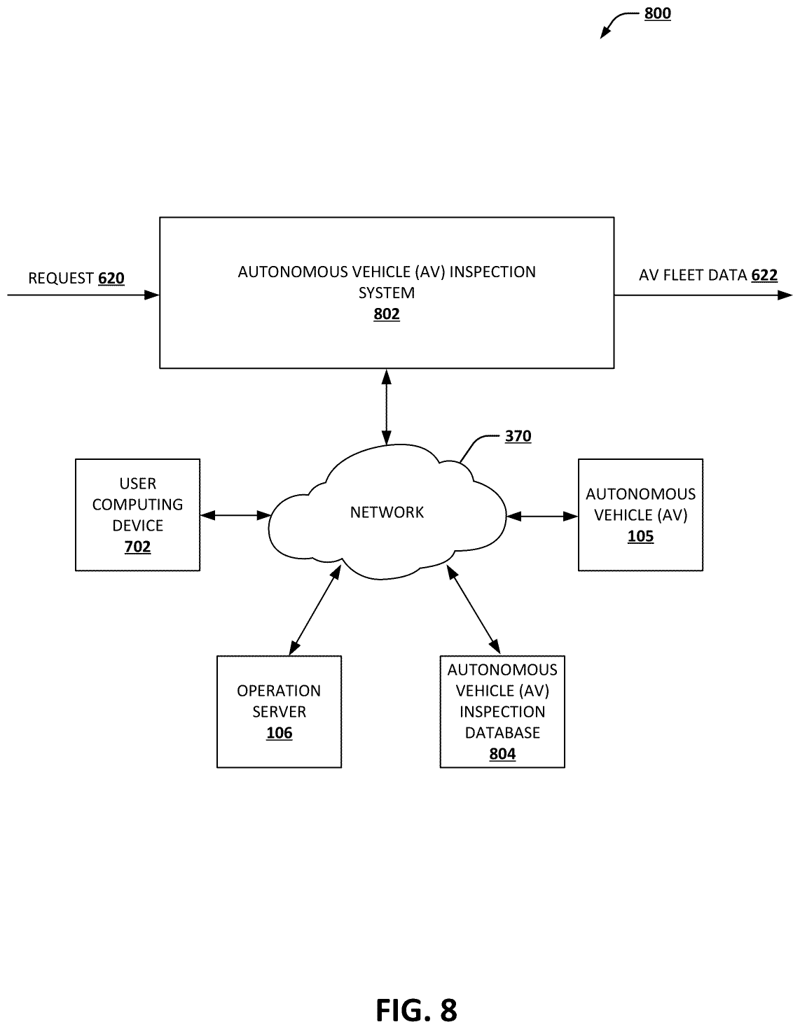

FIG. 8 illustrates a system 800 that provides another exemplary environment according to one or more described features of one or more embodiments of the disclosure. According to an embodiment, the system 800 includes an AV inspection system 802. In one or more embodiments, the AV inspection system 802 receives the request 620 from the user computing device system 602. In certain embodiments, the AV inspection system 802 receives the request 620 via the network 104. Additionally, in one or more embodiments, the AV inspection system 802 transmits the AV fleet data 622 to the user computing device system 602. In certain embodiments, the AV inspection system 802 transmits the AV fleet data 622 via the network 104. In one or more embodiments, the user computing device 702 includes the user computing device system 602. Additionally, in one or more embodiments, the user computing device 702 also includes the visual display 704, the one or more speakers 706, the one or more cameras 708, the one or more microphones 710, the GPS device 712, the gyroscope 714, the one or more wireless communication devices 716, and/or the power supply 718.

In various embodiments, the AV inspection system 802 receives data from multiple sources including, but not limited to, the operation server 106, the in-vehicle control computer 202 (e.g., from the data storage 210 comprised in the in-vehicle control computer 202), the application server 328, a user computing device 702, and/or one or more AVs 102. In one or more embodiments, at least a portion of the data from the operation server 106, the in-vehicle control computer 202, the application server 328, a user computing device 702, and/or one or more AVs 102 is included in the AV fleet data 622. In one or more embodiments, the operation server 106, the in-vehicle control computer 202, the application server 328, a user computing device 702, and/or one or more AVs 102 are associated with a fleet of AVs 102 owned and operated by a particular enterprise. For example, the fleet of AVs 102 can be associated with an enterprise including, but not limited to, a transportation enterprise, a logistics enterprise, a freight delivery enterprise, a retail enterprise, a manufacturing enterprise, an agricultural enterprise, an energy production enterprise, a travel enterprise, and/or any other type of relevant enterprise.

In one or more embodiments, the AV inspection system 802 receives data pertaining to one or more AV subsystems including, but not limited to, the control subsystem 214, vehicle drive subsystem 222, vehicle sensor subsystem 224, vehicle control subsystem 228 and each of the respective components comprised therein. The AV inspection system 802 can also receive data pertaining to one or more physical parts of an AV 102 not necessarily comprised in one of the named AV subsystems from above such as, for example, any physical components associated with the AV 102 such as mirrors, windows, doors, etc. Additionally, the AV inspection system 802 can receive data associated with any trailers and/or cargo associated with a particular AV 102. Additionally, the AV inspection system 802 is configured to receive data associated with any personnel related to a particular enterprise responsible for a particular AV 102 such as, for example, anu drivers, operators, ground crew, managers, administrator and/or any related third-party personnel.

In one or more embodiments, the AV inspection system 802 is in communication with one or more AVs 102 for selectively controlling the one or more AVs 102 and/or for sending/receiving data (e.g., AV subsystem data) between the AVs 102 and the AV inspection system 802 via the network 104. The data associated with the AVs 102 includes, for example, AV health data (e.g., operational status of one or more AV subsystems 212), sensor data, real-time travel data, event data, process data, operational data, fault data, mission data, location data, and/or other data associated with the AVs 102. In various embodiments, one or more portions of said data associated the AVs 102 can be comprised in the AV fleet data 622. Additionally or alternatively, the data associated with the AVs 102 includes historical data, historical AV health data, historical sensor data, historical travel data, historical event data, historical process data, historical operational data, historical fault data, historical mission data, historical location data, and/or other historical data associated with the AVs 102. In various embodiments, one or more portions of said historical data associated the AVs 102 can be comprised in the AV fleet data 622.

In one or more embodiments, the AV inspection system 802 receives the data associated with the AVs 102 via the network 104. In one or more embodiments, the network 104 is a Wi-Fi network, a near field communication (NFC) network, a WiMAX network, a personal area network (PAN), a short-range wireless network (e.g., a Bluetooth® network), an infrared wireless (e.g., IrDA) network, an ultra wideband (UWB) network, an induction wireless transmission network, and/or another type of network.

In one or more embodiments, the AV inspection system 802 aggregates the data associated with the AVs 102. For instance, in one or more embodiments, the AV inspection system 802 aggregates the data associated with the AVs 102 into an autonomous vehicle (AV) inspection database 804. The AV inspection database 804 is a cache memory (e.g., a database structure) that dynamically stores the data associated with the AVs 102. Additionally or alternatively, the AV inspection system 802 can transmit and/or store the aggregated data associated with AVs 102 to the operation server 106 (e.g., in the memory 304 of the operation server 106).

In one or more embodiments, the AV inspection system 802 repeatedly updates data of the AV inspection database 804 based on the data provided by the AVs 102 during the one or more intervals of time associated with the AV inspection database 804. For instance, in one or more embodiments, the AV inspection system 802 stores new AV inspection data and/or modified data associated with the progress of one or more dynamic inspection task checklists associated with the AVs 102. In one or more embodiments, the AV inspection system 802 formats one or more portions of the data associated with the AVs 102. For instance, in one or more embodiments, the AV inspection system 802 provides a formatted version of the data associated with the AVs 102 to the AV inspection database 804.

In various embodiments, the AV inspection system 802 is configured to inspect, diagnose, test, and/or report on the one or more respective components of the control subsystem 214, vehicle drive subsystem 222, vehicle sensor subsystem 224, and/or vehicle control subsystem 228 associated with an AV 102. The AV inspection system 802 is configured to assist the inspection, diagnosis, testing, and/or reporting of the one or more respective components of the control subsystem 214, vehicle drive subsystem 222, vehicle sensor subsystem 224, and/or vehicle control subsystem 228 associated with an AV 102. Furthermore, the AV inspection system 802 is configured to assist the inspection, diagnosis, testing, and/or reporting of one or more physical components associated with an AV 102 not necessarily comprised within the above-mentioned AV subsystems 212.

Based in part on the AV fleet data 622, the AV inspection system 802 can generate one or more dynamic inspection task checklists associated with one or more respective AV subsystems 212 for one or more particular inbound and/or outbound AVs 102 in a particular AV travel hub. Vehicle inspectors associated with respective vehicle inspector profiles can be located at a respective AV travel hub and employ the AV inspection system 802 to assist with and/or execute various AV inspection tasks associated with one or more AVs 102 in order to certify that the one or more respective AVs 102 are capable of transitioning into an autonomous driving mode and navigating unmanned to another destination.

The AV inspection system 802 can generate one or more dynamic inspection task checklists associated with one or more respective AVs 102 based on the type of vehicle. For example, a dynamic inspection task checklist generated for a sedan and/or a sport utility vehicle (SUV) might be fundamentally different than a dynamic inspection task checklist generated for a tractor-trailer. As a non-limiting example, the AV inspection system 802 can generate a dynamic inspection task checklist associated with a particular trailer being towed by a respective tractor. Such a dynamic inspection task checklist would be unnecessary for an AV 102 such as a sedan or SUV.

The AV inspection system 802 can be configured to generate one or more dynamic inspection task checklists based on an enterprise-defined task protocol such that a preferred AV inspection methodology and/or AV inspection protocol can be executed by one or more vehicle inspectors. For example, the AV inspection system 802 can generate one or more dynamic inspection task checklists for a particular AV 102 based on a particular enterprise-defined task protocol. The enterprise-defined task protocol can be based on a specific configuration of inspection task data objects that correspond to respective AV inspection tasks associated with one or more AV subsystems (e.g., vehicle drive subsystem 222). An enterprise can re-define the task protocol by reconfiguring, restructuring, re-sequencing, and/or re-ordering the one or more inspection task data objects and, as a result, the AV inspection system can generate new dynamic inspection task checklists based on the reconfigured enterprise-defined task protocol.

Furthermore, the AV inspection system 802 can cause an AV 102 to execute an automated self-check protocol. A user computing device 702 associated with a vehicle inspector profile that is associated with the AV inspection system 802 can direct, via a communications network (e.g., network 104), an in-vehicle control computer 202 aboard an AV 102 to execute one or more automated diagnostic procedures. The one or more automated diagnostic procedures can cause one or more components associated with one or more respective AV subsystems to automatically execute various self-checks configured to test the operational capacities of the one or more AV subsystem components. An automatic self-check protocol can direct the in-vehicle control computer 202 to cause the one or more AV subsystem components to execute automated diagnostic procedures such as, but not limited to, automatic power cycling of the AV subsystem components, automatic engagement of the AV subsystem components, various stress-tests associated with the AV subsystem components, various network connectivity tests associated with the AV subsystem components, various sensor data collection tests, and/or the like. The AV inspection system 802 can determine whether the AV subsystem components satisfy a respective predetermined performance threshold during the execution of the automated diagnostic procedures and indicate whether the one or more AV subsystem components have passed or failed the self-checks on an interactive inspection interface 902 of a user computing device 702 associated with an inspector profile.

Based in part on the successful completion of a plurality of dynamic inspection task checklists and/or the successful completion of an automated self-check protocol associated with a particular AV 102, the AV inspection system 802 can determine whether the particular AV 102 is capable of transitioning into an autonomous driving mode such that the AV 102 can be operated unmanned on public streets and highways. For example, the AV 102 may be determined to be capable of transitioning into an autonomous driving mode in an instance in which the plurality of dynamic inspection task checklists are successfully completed and/or in an instance in which the automated self-check protocol is successfully completed. However, if one or more of the dynamic inspection task checklists are not successfully completed or if the automated self-check protocol is not successfully completed, the AV 102 may be determined to not be capable of transitioning into an autonomous driving mode, at least not at the present time. If an AV 102 is certified to transition into the autonomous driving mode, a user computing device 702 associated with a vehicle inspector profile can deploy the AV 102 to a next destination. For example, a vehicle inspector can issue a deployment command to a particular AV 102 based on an interaction with the interactive inspection interface 902 associated with the AV inspection system 802 such that the in-vehicle control computer 202 associated with the AV 102 assumes control. Once the in-vehicle control computer 202 assumes control of the AV 102, the in-vehicle control computer 202 can direct the AV 102 to engage various subsystems configured to operate the AV 102 autonomously such that the AV 102 will travel unmanned to a next destination corresponding to a particular mission plan assigned to the AV 102.

The AV inspection system 802 is also configured to generate one or more interactive post-inspection reports summarizing the various dynamic inspection task checklists completed in relation to a particular AV 102. For example, the AV inspection system 802 can compile and organize an interactive post-inspection report associated with a particular AV 102 and transmit the interactive post-inspection report to the operation server 106 and/or an application server 328 associated with the enterprise responsible for the AV 102. Additionally, the AV inspection system 802 can generate documentation based on the interactive post-inspection report that describes how the AV 102 is in compliance with various safety standards and regulations. For instance, the AV inspection system 802 can generate one or more post-inspection audit reports based on the interactive post-inspection report. In the event that highway patrol and/or safety personnel need to weigh, inspect, and/or otherwise engage the AV 102, the post-inspection audit report can provide the necessary documentation needed to demonstrate that the AV 102 is in compliance with local safety standards and regulations.

In one or more embodiments, the user computing device 702 is in communication with the AV inspection system 802 via the network 104. In one or more embodiments, the user computing device 702 is a mobile computing device, a smartphone, a tablet computer, a mobile computer, a desktop computer, a laptop computer, a workstation computer, a wearable device, a virtual reality device, an augmented reality device, or another type of computing device located remote from the AV inspection system 802. In an embodiment, the user computing device 702 transmits the request 620 to the AV inspection system 802 via the network 104. For instance, in one or more embodiments, the user computing device 702 of the user computing device 702 transmits the request 620 to the AV inspection system 802 via the network 104. In another embodiment, the AV inspection system 802 transmits the AV fleet data 622 to the user computing device 702 via the network 104. For instance, in one or more embodiments, the AV inspection system 802 communicates the AV fleet data 622 to the user computing device system 602 of the user computing device 702 via the network 104.

In one or more embodiments, the AV fleet data 622 includes one or more visual elements for the visual display 704 of the user computing device 702 that renders the interactive inspection interface based on a respective user interface configuration. In certain embodiments, the visual display 704 of the user computing device 702 displays one or more graphical elements associated with the AV fleet data 622. In certain embodiments, the visual display 704 of the user computing device 702 presents one or more interactive display elements associated with the AV fleet data 622. In another example, in one or more embodiments, the AV fleet data 622 includes one or notifications associated with the AV fleet data 622. In one or more embodiments, the AV fleet data 622 allows a user associated with the user computing device 702 to make decisions and/or perform one or more actions with respect to the one or more AVs 102.

In various embodiments, the interactive inspection interface rendered via the visual display 704 of the user computing device 702 allows filtering of the AV fleet data and/or related interactive display elements. Additionally, one or more actions performed with respect to interactive display elements of the interactive inspection interface of the user computing device 702 can initiate one or more actions with respect to the AV inspection system 802. For example, one or more actions performed with respect to interactive display elements of the interactive inspection interface of the user computing device 702 can initiate an update to data stored in the AV inspection database 804 and/or an enterprise task protocol management portion of the AV inspection system 802.

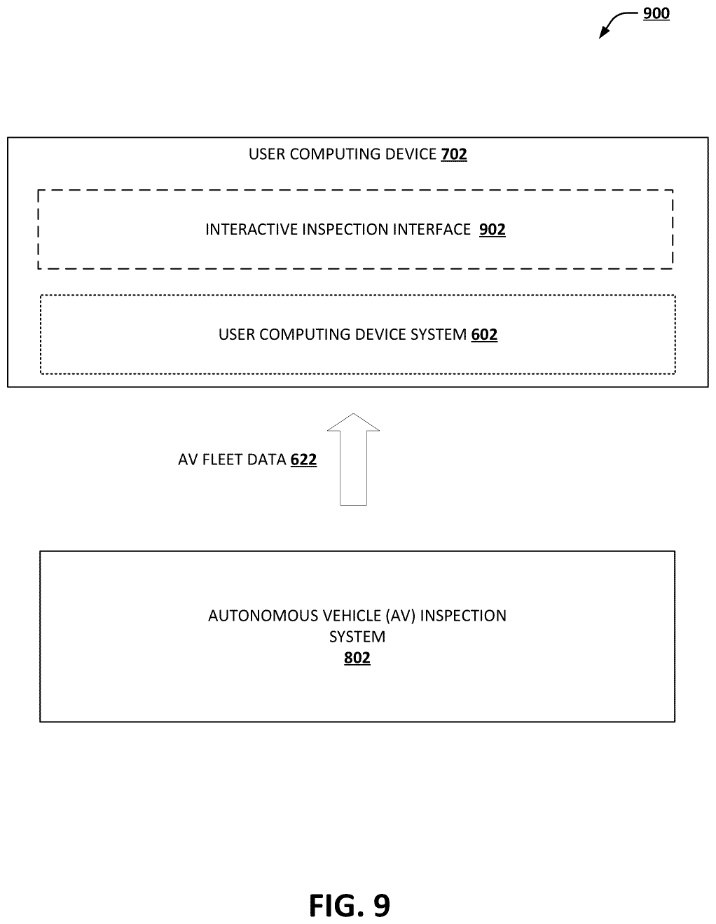

FIG. 9 illustrates an exemplary system 900 associated with an interactive inspection interface, in accordance with some embodiments discussed in the present disclosure. In an embodiment, the system 900 includes the user computing device 702 and the AV inspection system 802. In one or more embodiments, the user computing device 702 includes the user computing device system 602 to facilitate generation of an interactive inspection interface 902. In one or more embodiments, the interactive inspection interface 902 is rendered via the visual display 704 of the user computing device system 602. Furthermore, in certain embodiments, the AV inspection system 802 is communicatively coupled to a user computing device 702, an operation server 1550, and/or an in-vehicle control computer 202 associated with an AV 102.

The interactive inspection interface 902 is associated with a dashboard visualization service (e.g., an AV inspection service). In one or more embodiments, the interactive inspection interface 902 is accessible and/or implemented via the user computing device 702. In one or more embodiments, the interactive inspection interface 902 is configured to provide the interactive inspection interface associated with the AV fleet data 622 and/or one or more dynamic inspection task checklists generated based in part on the AV fleet data 622. In one or more embodiments, the AV inspection system 802 is configured to provide the AV fleet data 622 to the user computing device 702 to facilitate rendering of the interactive inspection interface 902 related to the AV fleet and/or one or more dynamic inspection task checklists.

### Example Processes of the Present Disclosure

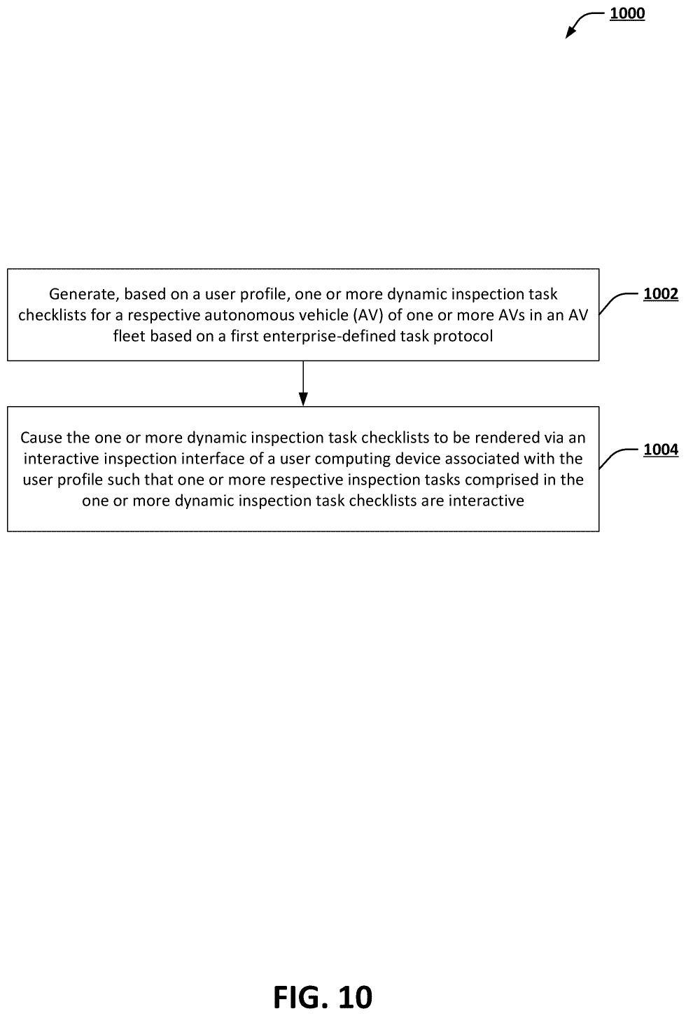

FIG. 10 is a process flow diagram of an example process 1000 for generating one or more dynamic inspection task checklists for an AV 102 based on a user profile in accordance with some embodiments discussed herein. In some embodiments, the process 1000 is embodied by computer program code stored on a non-transitory computer-readable storage medium of a computer program product configured for execution to perform the process as depicted and described.

Additionally or alternatively, in some embodiments, the process 1000 is performed by one or more specially configured computing devices, such as the user computing device system 602 alone or in communication with one or more other component(s), device(s) (e.g., user computing device 702), and/or system(s) (e.g., AV inspection system 802). In this regard, in some such embodiments, the user computing device system 602 is specially configured by computer-coded instructions (e.g., computer program instructions) stored thereon, for example in the memory 612 and/or another component depicted and/or described herein and/or otherwise accessible to the user computing device system 602, for performing the operations as depicted and described. In some embodiments, the user computing device system 602 is in communication with one or more external apparatus(es), system(s), device(s), and/or the like, to perform one or more of the operations as depicted and described. For example, the user computing device system 602 in some embodiments is in communication with one or more system(s) integrated with, or embodying, an autonomous vehicle network platform (e.g., user computing device system 602 embodied by an autonomous vehicle network platform and integrated with the AV inspection system 802). For purposes of simplifying the description, the process 1000 is described as performed by and from the perspective of the user computing device system 602.

The process 1000 begins at operation 1002. At operation 1002, the user computing device system 602 includes means, such as the communication component 604, the autonomous vehicle (AV) inspection component 606, the user interface component 608, the processor 610, and/or the memory 612, or any combination thereof, that generates, based on a user profile, one or more dynamic inspection task checklists for a respective AV 102 of one or more AVs in an AV fleet based on a first enterprise-defined task protocol, where the one or more dynamic inspection task checklists are associated with one or more respective AV subsystems 212, and where the user profile is associated with a respective user role such that the one or more dynamic inspection task checklists differ dependent upon the respective user role.

For example, in various embodiments, the AV inspection system 802 allows an enterprise to determine an enterprise-defined task protocol such that a preferred inspection methodology and/or protocol can be executed by one or more vehicle inspectors. For example, the AV inspection system 802 can generate one or more dynamic inspection task checklists for a particular AV 102 based on a particular enterprise-defined task protocol. The enterprise-defined task protocol can be based on a specific configuration of inspection task data objects that correspond to respective AV inspection tasks associated with one or more AV subsystems 212. An enterprise can re-define the task protocol by reconfiguring, restructuring, re-sequencing, and/or re-ordering the one or more inspection task data objects and, as a result, the AV inspection system 802 can generate new dynamic inspection task checklists based on the reconfigured enterprise-defined task protocol.

In various embodiments, a user role that is associated with a particular user profile can affect the availability of various permissions, configurations, and/or actions associated with the AV inspection system 802 for the user profile associated with the respective user role. Additionally, the AV inspection system 802 can determine certain configurations and parameters associated with one or more dynamic inspection task checklists related to one or more AVs 102. In certain embodiments, one or more dynamic inspection task checklists are generated based in part on the user role associated with the respective user profile.

At operation 1004, the user computing device system 602 includes means, such as the communication component 604, the autonomous vehicle (AV) inspection component 606, the user interface component 608, the processor 610, and/or the memory 612, or any combination thereof, that causes the one or more dynamic inspection task checklists to be rendered via an interactive inspection interface of a user computing device associated with the user profile such that one or more respective inspection tasks comprised in the one or more dynamic inspection task checklists are interactive.

For example, in one or more embodiments, the user computing device system 602 interacts with the operation server 106 to facilitate providing an interactive inspection interface 902 associated with dynamic inspection task checklists related to one or more AVs 102. In various embodiments, the interactive inspection interface 902 is configured as a dashboard visualization associated with one or more AVs 102 associated with an AV fleet, where the visualization data comprises one or more pieces of data related to, but not limited by, AV identification data, AV subsystem data (e.g., data related to control subsystem 214, vehicle drive subsystem 222, vehicle sensor subsystem 224, vehicle control subsystem 228), AV location data, mission data, AV log data, routing data (e.g., routing plan 312), AV trailer data, AV cargo data, and/or the like.

The user interface component 608 is configured to render an interactive inspection interface 902 via a display of a user computing device 702. In one or more embodiments, the interactive inspection interface 902 is configured as a dashboard visualization rendered via a display of a user computing device 702. In one or more embodiments, the interactive inspection interface 902 is configured to provide dynamic interaction with prioritized AV inspection tasks that are rendered as respective interactive display elements via the interactive inspection interface 902. An interactive display element is a portion of the interactive inspection interface (e.g., a user-interactive electronic interface portion) that provides interaction with respect to an end user of the user computing device. For example, in one or more embodiments, an interactive display element is an interactive display element associated with a set of pixels that allows a user to provide feedback and/or to perform one or more actions with respect to the interactive inspection interface 902. Non-limiting examples of interactive display elements can include interactive buttons, hyperlinks, graphs, charts, tables, and/or text input fields.

In an embodiment, in response to interaction with an interactive display element, the interactive inspection interface 902 is dynamically altered to display one or more altered portions of the interactive inspection interface 902 associated with different visual data and/or different interactive display elements. Additionally, in one or more embodiments, the interactive inspection interface 902 is configured to facilitate execution and/or initiation of one or more actions via the dashboard visualization based on the AV fleet data 622. In an embodiment, an action is executed and/or initiated via an interactive display element of the dashboard visualization. In certain embodiments, the interactive inspection interface 902 presents one or more notifications associated with the prioritized actions related to the AV fleet data 622.

The interactive inspection interface 902 displays respective interactive display elements associated with the AV fleet data 622. In one or more embodiments, the visual display 704 provides the interactive inspection interface that is configured to allow a user associated with the user computing device 702 to interact with respective user interface configurations of the interactive inspection interface. Additionally, in one or more embodiments, the visual display 704 provides the interactive inspection interface 902 that is configured to allow a user associated with the user computing device 702 to control the one or more interactive display elements associated with one or more AV inspection tasks comprised in the dynamic inspection task checklists. In one or more embodiments, the interactive inspection interface is configured based on user profile data and/or user privileges. In certain embodiments, user specific requirements associated with the interactive inspection interface is configured via a backend system (e.g., the AV inspection system 802). In one or more embodiments, the interactive inspection interface 902 is configured based on hardware and/or software specifications of the user computing device 702.

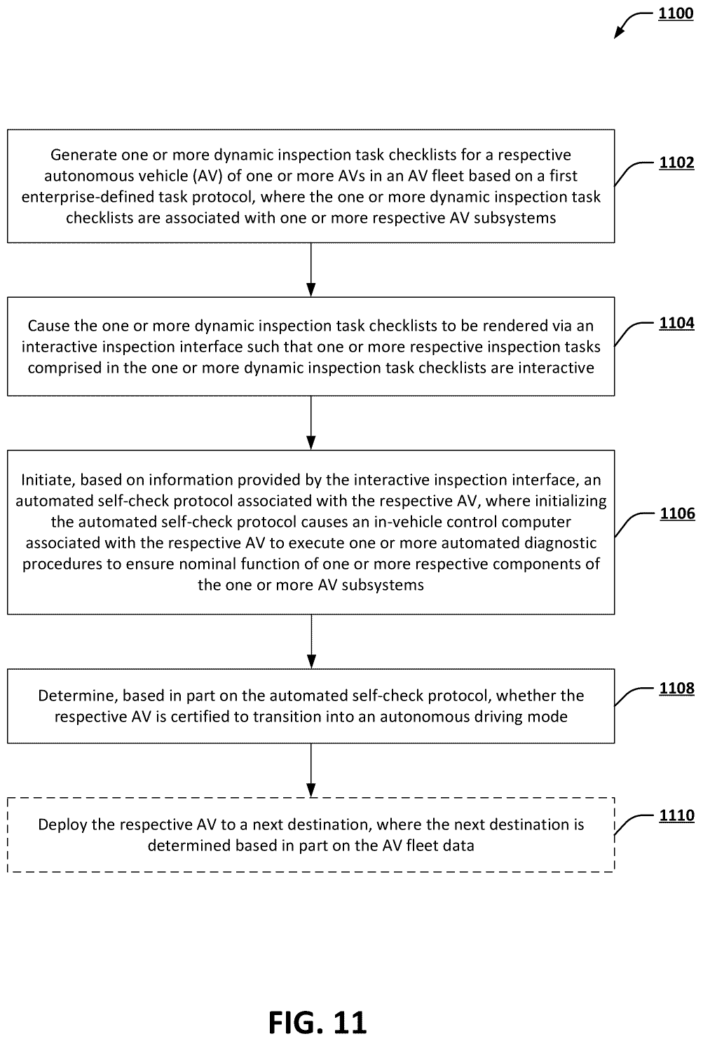

FIG. 11 is a process flow diagram of an example process 1100 for performing an AV inspection in accordance with some embodiments discussed herein. In some embodiments, the process 1100 is embodied by computer program code stored on a non-transitory computer-readable storage medium of a computer program product configured for execution to perform the process as depicted and described.

Additionally or alternatively, in some embodiments, the process 1100 is performed by one or more specially configured computing devices, such as the user computing device system 602 alone or in communication with one or more other component(s), device(s) (e.g., user computing device 702), and/or system(s) (e.g., AV inspection system 802). In this regard, in some such embodiments, the user computing device system 602 is specially configured by computer-coded instructions (e.g., computer program instructions) stored thereon, for example in the memory 612 and/or another component depicted and/or described herein and/or otherwise accessible to the user computing device system 602, for performing the operations as depicted and described. In some embodiments, the user computing device system 602 is in communication with one or more external apparatus(es), system(s), device(s), and/or the like, to perform one or more of the operations as depicted and described. For example, the user computing device system 602 in some embodiments is in communication with one or more system(s) integrated with, or embodying, an autonomous vehicle network platform (e.g., user computing device system 602 embodied by an autonomous vehicle network platform and integrated with the AV inspection system 802). For purposes of simplifying the description, the process 1100 is described as performed by and from the perspective of the user computing device system 602.

The process 1100 begins at operation 1102. At operation 1102, the user computing device system 602 includes means, such as the communication component 604, the autonomous vehicle (AV) inspection component 606, the user interface component 608, the processor 610, and/or the memory 612, or any combination thereof, that generates one or more dynamic inspection task checklists for a respective autonomous vehicle (AV) 102 of one or more AVs in an AV fleet based on a first enterprise-defined task protocol, where the one or more dynamic inspection task checklists are associated with one or more respective AV subsystems.

For example, the AV inspection system 802 can be configured to generate the one or more dynamic inspection task checklists based on an enterprise-defined task protocol such that a preferred AV inspection methodology and/or AV inspection protocol can be executed by one or more user computing device(s) 702 associated with a respective user profile related to a specific user role (e.g., a vehicle inspector). The enterprise-defined task protocol can be based on a specific configuration of inspection task data objects that correspond to respective AV inspection tasks associated with one or more AV subsystems 212 (e.g., vehicle drive subsystem 222). Non-limiting examples of the types of dynamic inspection task checklists the AV inspection system 802 can generate for an AV 102 include a general readiness checklist, an autonomous system checklist, a tractor inspection checklist, and a trailer inspection checklist. The general readiness checklist, the autonomous system checklist, the tractor inspection checklist, and the trailer inspection checklist can all be associated with one or more respective AV subsystems 212.

At operation 1104, the user computing device system 602 includes means, such as the communication component 604, the autonomous vehicle (AV) inspection component 606, the user interface component 608, the processor 610, and/or the memory 612, or any combination thereof, that causes the one or more dynamic inspection task checklists to be rendered via an interactive inspection interface such that one or more respective inspection tasks comprised in the one or more dynamic inspection task checklists are interactive.

For example, the interactive inspection interface 902 displays respective interactive display elements associated with the AV fleet data 622. In one or more embodiments, the visual display 704 provides the interactive inspection interface that is configured to allow a user associated with the user computing device 702 to interact with respective user interface configurations of the interactive inspection interface. Additionally, in one or more embodiments, the visual display 704 provides the interactive inspection interface 902 that is configured to allow a user associated with the user computing device 702 to control the one or more interactive display elements associated with one or more AV inspection tasks comprised in the dynamic inspection task checklists. In one or more embodiments, the interactive inspection interface is configured based on user profile data and/or user privileges. In certain embodiments, user specific requirements associated with the interactive inspection interface is configured via a backend system (e.g., the AV inspection system 802). In one or more embodiments, the interactive inspection interface 902 is configured based on hardware and/or software specifications of the user computing device 702.

At operation 1106, the user computing device system 602 includes means, such as the communication component 604, the autonomous vehicle (AV) inspection component 606, the user interface component 608, the processor 610, and/or the memory 612, or any combination thereof, that initiates, based on information provided by the interactive inspection interface, an automated self-check protocol associated with the respective AV, where initializing the automated self-check protocol causes an in-vehicle control computer associated with the respective AV to execute one or more automated diagnostic procedures to ensure nominal function of one or more respective components of the one or more AV subsystems.

For example, the AV inspection system 802 can cause an AV 102 to execute an automated self-check protocol. A user computing device 702 associated with a vehicle inspector profile that is associated with the AV inspection system 802 can direct, via a communications network (e.g., network 104), an in-vehicle control computer 202 aboard an AV 102 to execute one or more automated diagnostic procedures. The one or more automated diagnostic procedures can cause one or more components associated with one or more respective AV subsystems to automatically execute various self-checks configured to test the operational capacities of the one or more AV subsystem components.

An automatic self-check protocol can direct the in-vehicle control computer 202 to cause the one or more AV subsystem components to execute automated diagnostic procedures such as, but not limited to, automatic power cycling of the AV subsystem components, automatic engagement of the AV subsystem components, various stress-tests associated with the AV subsystem components, various network connectivity tests associated with the AV subsystem components, various sensor data collection tests, and/or the like. The AV inspection system 802 can determine whether the AV subsystem components satisfy a respective predetermined performance threshold during the execution of the automated diagnostic procedures and indicate whether the one or more AV subsystem components have passed or failed the self-checks on an interactive inspection interface 902 of a user computing device 702 associated with an inspector profile.

At operation 1108, the user computing device system 602 includes means, such as the communication component 604, the autonomous vehicle (AV) inspection component 606, the user interface component 608, the processor 610, and/or the memory 612, or any combination thereof, that determines, based in part on the automated self-check protocol, whether the respective AV is certified to transition into an autonomous driving mode.

For example, based in part on the successful completion of a plurality of dynamic inspection task checklists and/or the successful completion of an automated self-check protocol associated with a particular AV 102, the AV inspection system 802 can determine whether the particular AV 102 is capable of transitioning into an autonomous driving mode such that the AV 102 can operated unmanned on public streets and highways. For example, the AV 102 may be determined to be capable of transitioning into an autonomous driving mode in an instance in which the plurality of dynamic inspection task checklists are successfully completed and/or in an instance in which the automated self-check protocol is successfully completed. However, if one or more of the dynamic inspection task checklists are not successfully completed or if the automated self-check protocol is not successfully completed, the AV 102 may be determined to not be capable of transitioning into an autonomous driving mode, at least not at the present time. In addition, the results of the plurality of dynamic inspection task checklists and/or the result of the automated self-check protocol may be presented to a user, such as via the user interface component 608.

At optional operation 1110, the user computing device system 602 includes means, such as the communication component 604, the autonomous vehicle (AV) inspection component 606, the user interface component 608, the processor 610, and/or the memory 612, or any combination thereof, that deploys the respective AV to a next destination, where the next destination is determined based in part on the AV fleet data. If an AV 102 is certified to transition into the autonomous driving mode, a user computing device 702 associated with a vehicle inspector profile can deploy the AV 102 to a next destination. For example, a vehicle inspector can issue a deployment command to a particular AV 102 based on an interaction with the interactive inspection interface 902 associated with the AV inspection system 802 such that the in-vehicle control computer 202 associated with the AV 102 assumes control. Once the in-vehicle control computer 202 assumes control of the AV 102, the in-vehicle control computer 202 can direct the AV 102 to engage various subsystems configured to operate the AV 102 autonomously such that the AV 102 will travel unmanned to a next destination corresponding to a particular mission plan assigned to the AV 102.

### Operational Examples of the Present Disclosure

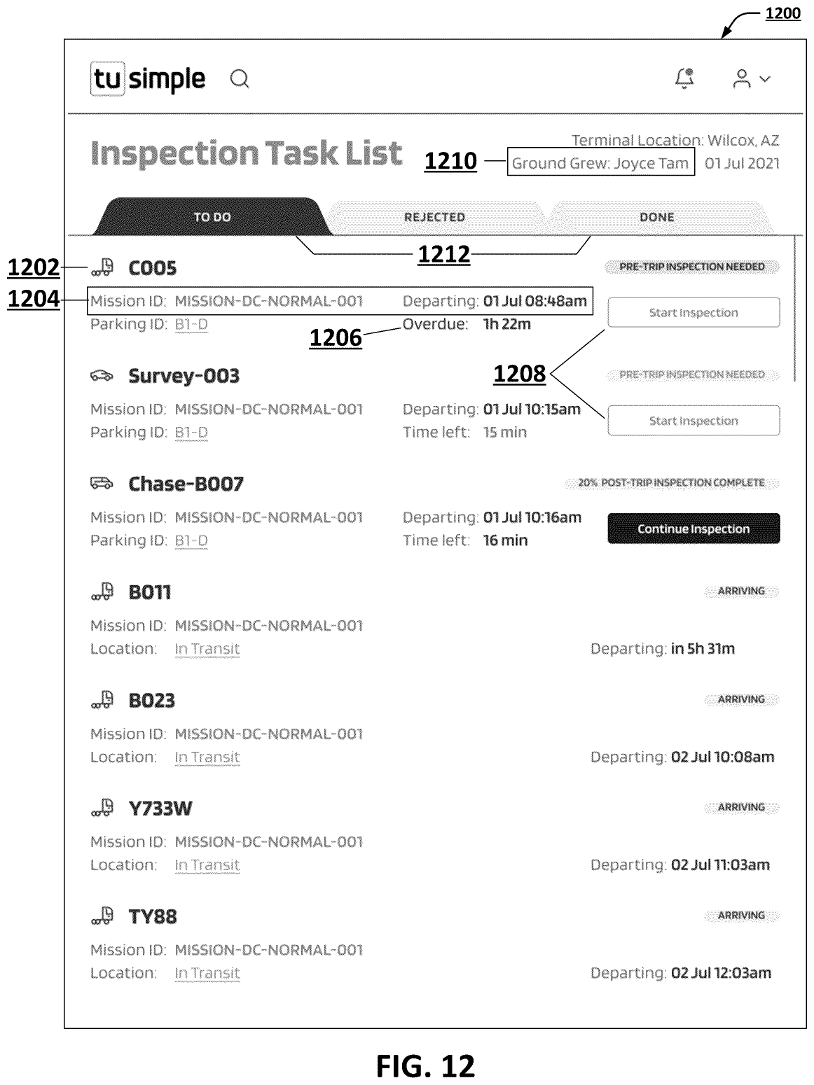

FIG. 12 is an operational example of an AV fleet inspection list 1200 in accordance with some embodiments discussed herein. In one or more embodiments, the AV inspection system 802 can generate an AV fleet inspection list 1200 for a particular user profile based in part on the AV fleet data 622. For instance, as depicted, FIG. 12 illustrates an operational example of an AV fleet inspection list 1200 generated for a user profile associated with user profile identifier 1210. In one or more embodiments, a user profile can be associated with a respective user role which can affect the availability of various permissions, configurations, and/or actions associated with the AV inspection system 802 for the user profile associated with the respective user role. For example, the user profile identifier 1210 describes the user role associated with the user profile as “Ground Crew.” User roles associated with respective user profiles can include, but are not limited by roles such as, a vehicle inspector, a maintenance engineer, a supervisor, a manager, a client, a stakeholder, an administrator, an operator, and/or a third-party that might have a reason to interact with an AV 102 and/or the AV inspection system such as a regulatory personnel or law enforcement personnel.

An AV fleet inspection list 1200 generated for a particular user profile can be associated with one or more inbound and/or outbound AVs 102 associated with a particular AV travel hub. A user computing device 702 can generate and/or render one or more interactive display elements associated with various portions of AV fleet data 622 that has been compiled by the AV inspection system 802 related to the AV fleet inspection list 1200. Non-limiting examples of interactive display elements can include interactive buttons, hyperlinks, graphs, charts, tables, and/or text input fields.

For example, the user computing device 702, in conjunction with the AV inspection system 802 can generate one or more interactive display elements such as the interactive display element 1202 rendered as an AV identifier, interactive display element(s) 1204 and 1206 associated with various portions of mission data, and/or interactive display element(s) 1208 and 1212 rendered as buttons. The various interactive display elements can be configured on the interactive inspection interface 902 such that an interaction the interactive display elements causes the user computing device 702 execute various actions such as, but not limited to, reconfiguring the interactive inspection interface 902, transmitting various signals to the AV inspection system 802 causing the AV inspection system 802 to execute various functions, transmitting signals to the operation server 106 causing the operation server 106 to execute various functions, and/or transmitting signals to the application server 328 causing the application server 328 to execute various functions.

The AV fleet inspection list 1200 can comprise one or more lists of AVs 102 that are in need of inspection, have undergone inspection, and/or have been rejected and/or otherwise flagged for removal from service. For instance, interactive display element(s) 1212 correspond to one or more AVs 102 in associated with various statuses. In some embodiments, the AV fleet inspection list 1200 can be generated for a particular user profile such that the AV fleet inspection list 1200 corresponds only to one or more AVs 102 that have been assigned to the particular user profile for inspection. In other embodiments, the AV fleet inspection list 1200 corresponds to one or more AVs 102 that are inbound to or outbound from a particular AV travel hub.

In one or more embodiments, AV identifier data, such as the AV identifier rendered by the interactive display element 1202, can be used to identify various components of an AV 102. For example, in some embodiments, various AV identifiers can include, but are not limited to, truck IDs, trailer IDs, load IDs, car IDs, SUV IDs, cargo Ids, and/or the like. In various embodiments, one or more AV identifiers can be generated by the operation server 106. In various other embodiments, AV identifiers can be generated by the AV inspection system 802. In one or more embodiments, one or more AV identifiers can be associated with one or more vehicle identifiers issued by a governing body, such as, for example, the Department of Motor Vehicles (DMV). Such vehicle identifiers can include, but are not limited to, license plate numbers, trailer numbers, vehicle identification numbers (VINs), and/or any other various identifiers associate with an AV 102 that has been issued by a regulatory body.

In various embodiments, various portions of mission data associated with a particular AV 102 can be rendered as one or more respective interactive display elements on the interactive inspection interface 902. The mission data can comprise, but is not limited to, mission identification data, logistical data comprising arrival and departure locations, arrival and departure times, inspection duration data, down time data (e.g., amount of time stopped at a travel hub for inspection, maintenance, loading, and/or scheduling constraints), and/or the like. For example, interactive display elements 1204 and 1206 are configured to display portions of mission data. Interactive display element 1204 corresponds to a mission identifier and corresponding departure time associated with a particular AV 102, and interactive display element 1206 is configured to display a current inspection status associated with the particular AV 102 derived based on the corresponding departure time depicted by interactive display element 1204.

In one or more embodiments, an interaction with one or more interactive display elements rendered on the interactive inspection interface 902 can initialize one or more processes and/or actions associated with a particular AV 102. For example, an interaction with the interactive display element(s) 1208 can cause the AV inspection system 802 to generate one or more dynamic inspection task checklists for a particular AV 102 based in part on one or more portions of AV fleet data 622.

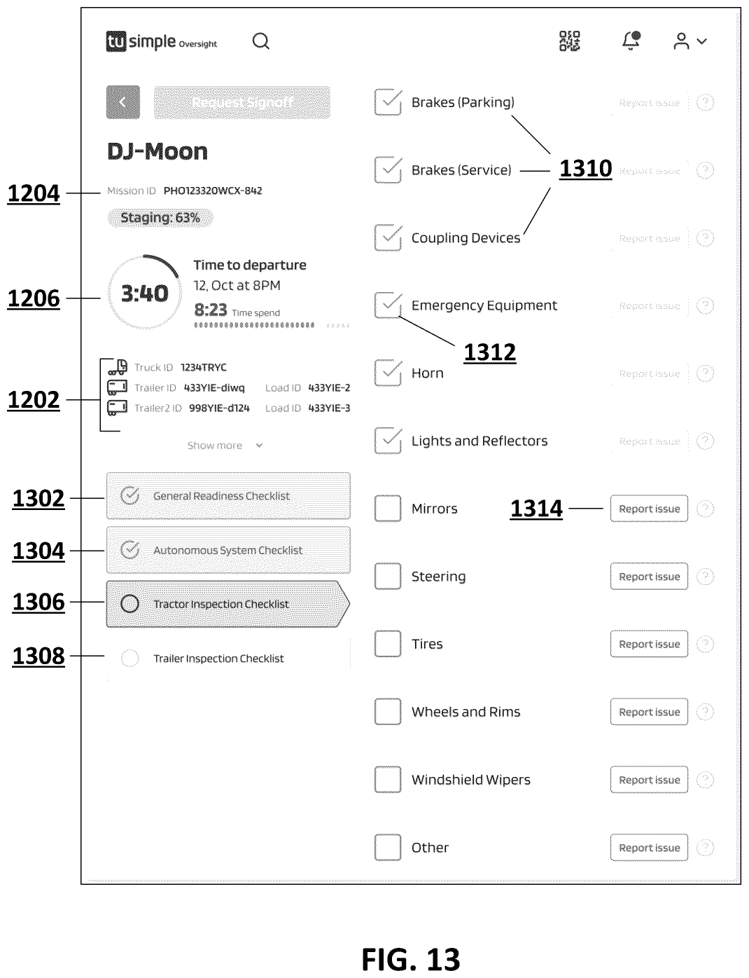

FIG. 13 is an operational example of a dynamic inspection task checklist associated with an AV 102 in accordance with some embodiments discussed herein. Specifically, FIG. 13 illustrates a configuration of the interactive inspection interface 902 as it would appear while a dynamic inspection task checklist 1306 associated with a tractor related to the AV 102 was in progress. On the left-hand side, various portions of AV identification data and mission data are rendered as respective interactive display elements. For example, interactive display element 1202 comprises AV identification data associated with the AV 102 such as a truck ID, two trailer IDs, and two respective load IDs related to the two trailer IDs. Furthermore, the interactive display elements 1204 and 1206 depict various portions of mission data such as a mission ID and a mission status, respectively.

In one or more embodiments the AV inspection system 802 can generate one or more respective dynamic inspection task checklists associated with a particular AV 102. The AV inspection system 802 can generate one or more dynamic inspection task checklists associated with one or more respective AV subsystems 212 for one or more particular inbound and/or outbound AVs 102 in a particular AV travel hub. For example, FIG. 13 illustrates operational examples of multiple dynamic inspection task checklists that have been generated for the AV 102 identified by the interactive display elements 1202-1204.

For example, the AV inspection system 802 has generated a general readiness checklist 1302, an autonomous system checklist 1304, a tractor inspection checklist 1306, and a trailer inspection checklist 1308. The general readiness checklist 1302, the autonomous system checklist 1304, the tractor inspection checklist 1306, and the trailer inspection checklist 1308 can all be associated with one or more respective AV subsystems 212. For example, the autonomous system checklist 1304 can be associated with the vehicle sensor subsystem 224 (e.g., cameras 226a, radar 226b) and/or the vehicle control subsystem 228 (e.g., autonomous control unit 228e). Similarly, the tractor inspection checklist 1306 can be associated with the vehicle drive subsystem 222 (e.g., wheels/tires 222b) and/or vehicle control subsystem 228 (e.g., brake unit 228b).

FIG. 13 illustrates that the tractor inspection checklist 1306 is in progress and, as such, only a few of the AV inspection tasks 1310 have been indicated as complete. Various interactive display elements (e.g., interactive display element 1312) can be configured to indicate whether a particular AV inspection task has been completed. Furthermore, interactive display elements such as the interactive display element 1312 can be configured to indicate whether the particular AV inspection task has been completed successfully or unsuccessfully. It is readily apparent that the interactive display element 1312 indicates whether a corresponding component part associated with the AV 102 (e.g., the parking brakes, coupling devices, horn, and/or lights and reflectors, etc.) have successfully passed inspection.

In some circumstances, an end user associated with a user profile can indicate the successful completion of an AV inspection task (e.g., AV inspection tasks 1310) via the interactive inspection interface 902 of a user computing device 702 (e.g., such as by selecting an interactive display element 1312 or the like). In other circumstances, the AV inspection system 802 can cause one or more component parts to undergo an automated self-check protocol and the AV inspection system 802 can automatically indicate on the interactive inspection interface 902 (e.g., by way of an interactive display element 1312 or the like) whether the one or more component parts associated with the AV inspection task has successfully passed inspection and/or an automated diagnostic procedure.

The AV inspection system 802 can be configured to generate the one or more dynamic inspection task checklists based on an enterprise-defined task protocol such that a preferred AV inspection methodology and/or AV inspection protocol can be executed by one or more user computing device(s) 702 associated with a respective user profile related to a specific user role (e.g., a vehicle inspector). For example, the AV inspection system 802 can generate the dynamic inspection task checklists 1302-1308 for the AV 102 based on a particular enterprise-defined task protocol. The enterprise-defined task protocol can be based on a specific configuration of inspection task data objects that correspond to respective AV inspection tasks associated with one or more AV subsystems (e.g., vehicle drive subsystem 222). An enterprise can re-define the task protocol by reconfiguring, restructuring, re-sequencing, and/or re-ordering the one or more inspection task data objects and, as a result, the AV inspection system 802 can generate new dynamic inspection task checklists based on the reconfigured enterprise-defined task protocol.

The enterprise-defined task protocol can be a predetermined sequence and/or ordering of a plurality of AV inspections tasks associated with a respective dynamic inspection task checklist related to a respective AV subsystem. Additionally, the enterprise-defined task protocol can be updated, re-sequenced, and/or re-ordered at any time by way of the user computing device system 602. For example, the user interface component 608 can arrange a plurality of inspection task data objects associated with a respective plurality of AV inspection tasks related to one or more AV subsystems 212. For instance, the user interface component 608 can configure the plurality of inspection task data objects as interactive display elements on the interactive inspection interface such that an end user can manipulate the inspection task data objects, thereby rearranging, re-sequencing, re-ordering, and/or updating the corresponding enterprise-defined task protocol.

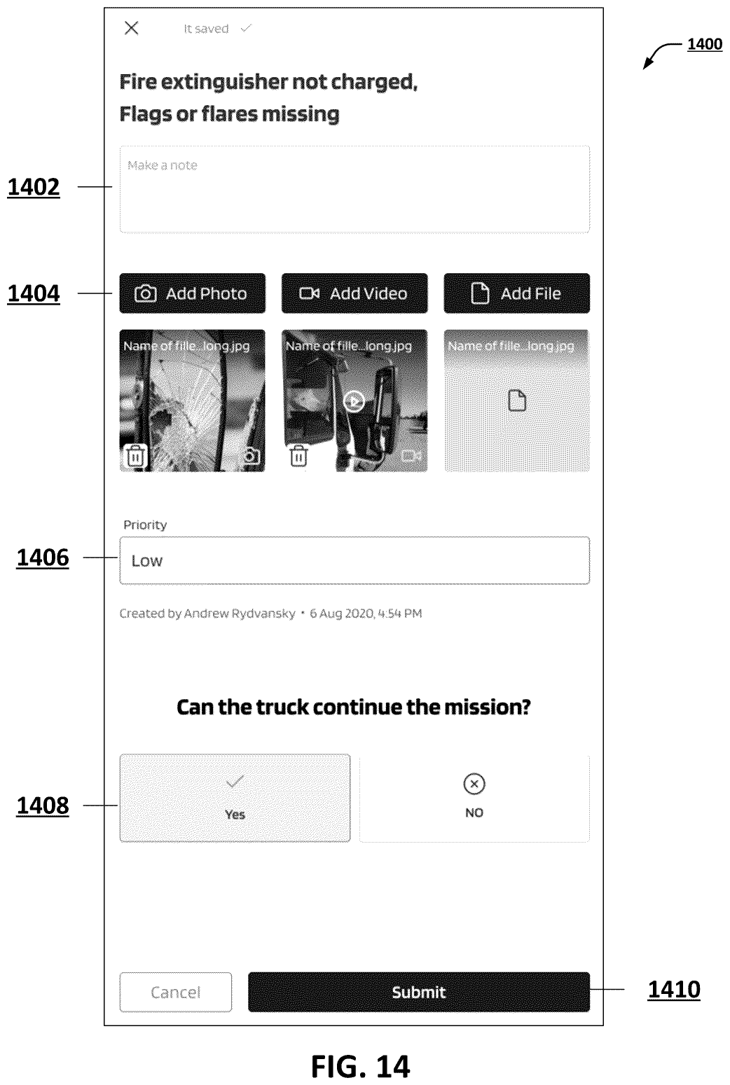

FIG. 14 is an operational example of an inspection task issue reporting interface 1400 in accordance with some embodiments discussed herein. In the event that a particular component part of the AV 102 associated with a particular AV inspection task (e.g., AV inspection tasks 1310) fails to pass a human inspection and/or an automated inspection, the AV inspection system 802 is configured to generate one or more inspection task issue reports associated with a respective AV inspection task via an interaction with the inspection task issue reporting interface 1400. For example, in the event that one or more mirrors associated with the AV 102 is broken, the AV inspection system 802 can generate an inspection task issue reporting interface 1400 associated with the AV inspection task associated with the mirrors. For instance, the AV inspection system 802 can generate the inspection task issue reporting interface 1400 in response to an interaction with an interactive display element 1314 configured on the interactive inspection interface 902 as an interactive button.

In various embodiments, an inspection task issue reporting interface 1400 comprises various interactive display elements 1402-1410 configured to initiate various actions associated with the user computing device 702 as well as the AV inspection system 802. For instance, the interactive display element 1402 configured as a text field is configured to facilitate text generation by an end user associated with a user profile related to the user computing device 702 rendering the inspection task issue reporting interface 1400. Likewise, an interaction with the interactive display element 1404 can cause the user computing device 702 to open a camera app and employ camera(s) 708 to capture image data associated with one or more component parts related to one or more AV subsystems 212 associated with the AV 102 (e.g., mirrors, wheels, windows, body parts, electronics, interior components, and/or the like). The AV inspection system 802 can store the captured image data in the AV vehicle inspection database 804. Additionally or alternatively, the AV inspection system 802 can transmit the capture image data to the operation server 106.

In various embodiments, when a component part of the AV 102 fails inspection and/or an inspection task issue reporting interface 1400 is generated in relation to a particular AV inspection task (e.g., AV inspection tasks 1310), the user computing device 702 can assign an issue priority to the respective inspection task issue report. For example, the interactive display element 1406 configured as an interactive drop-down menu on the inspection task issue reporting interface 1400 can be used to assign an issue priority to an inspection task issue report via the inspection task issue reporting interface 1400. Issue priorities can be used to classify the severity of a particular issue related to a respective AV inspection task. Non-limiting examples of issue priority classifications related to AV inspection tasks comprise low priority, medium priority, high priority, and/or critical priority.

In some embodiments, an issue priority threshold can be defined by the AV inspection system 802 such that certain actions are automatically executed when a particular inspection task issue report is assigned an issue priority at or above the issue priority threshold. For example, in some embodiments, if an inspection task issue reporting interface 1400 associated with an AV inspection task (e.g., AV inspection tasks 1310) is employed to submit an inspection task issue report with a critical issue priority, the AV inspection system 802 can automatically cause a suspension signal to be transmitted to the operation server 106. Additionally or alternatively, in some embodiments, if the inspection task issue reporting interface 1400 associated with an AV inspection task is employed to submit an inspection task issue report exceeding the issue priority threshold, the AV inspection system 802 can automatically transmit a hard-stop command to an in-vehicle control computer 202 associated with the respective AV 102 that has failed inspection.

In various embodiments, the inspection task issue reporting interface 1400 can be employed to generate a mission recommendation associated with a mission plan associated with the respective AV 102. For example, the mission recommendation can be a recommendation that the AV 102 continues the mission or a recommendation that the AV 102 discontinues the mission. In various embodiments, the mission data associated with the AV 102 can be automatically updated depending on the mission recommendation generated by the inspection task issue reporting interface 1400. In various embodiments, the AV 102 can be decommissioned and/or pulled from the AV fleet based on the mission recommendation and/or the issue priority associated with the AV inspection task for which the inspection task issue report has been generated. For example, based on the mission recommendation and/or the issue priority it can be determined that the AV 102 can no longer operate until the respective component part associated with the inspection task issue report is repaired and/or replaced and the AV 102 can continue to operate safely.

In various embodiments, interactive display elements such as the interactive display element 1410 can be employed to submit an inspection task issue report. The AV inspection system 802 can store the one or more inspection task issue reports in the AV vehicle inspection database 804. Additionally or alternatively, the AV inspection system 802 can transmit the one or more inspection task issue reports to the operation server 106.

In one or more embodiments, upon submission of the inspection task issue report, maintenance for the AV subsystem component may be performed or schedule. For example, a maintenance e-ticket can be automatically generated for the AV subsystem component for which an inspection task issue report has been generated. In one or more embodiments, the AV inspection system 802 can generate the maintenance e-ticket. In various other embodiments, the operation server 106 can generate the maintenance e-ticket. In still other embodiments, the AV inspection system 802 can integrate with an AV maintenance and repair ticketing system associated with the enterprise responsible for the AV fleet comprising the AV 102.

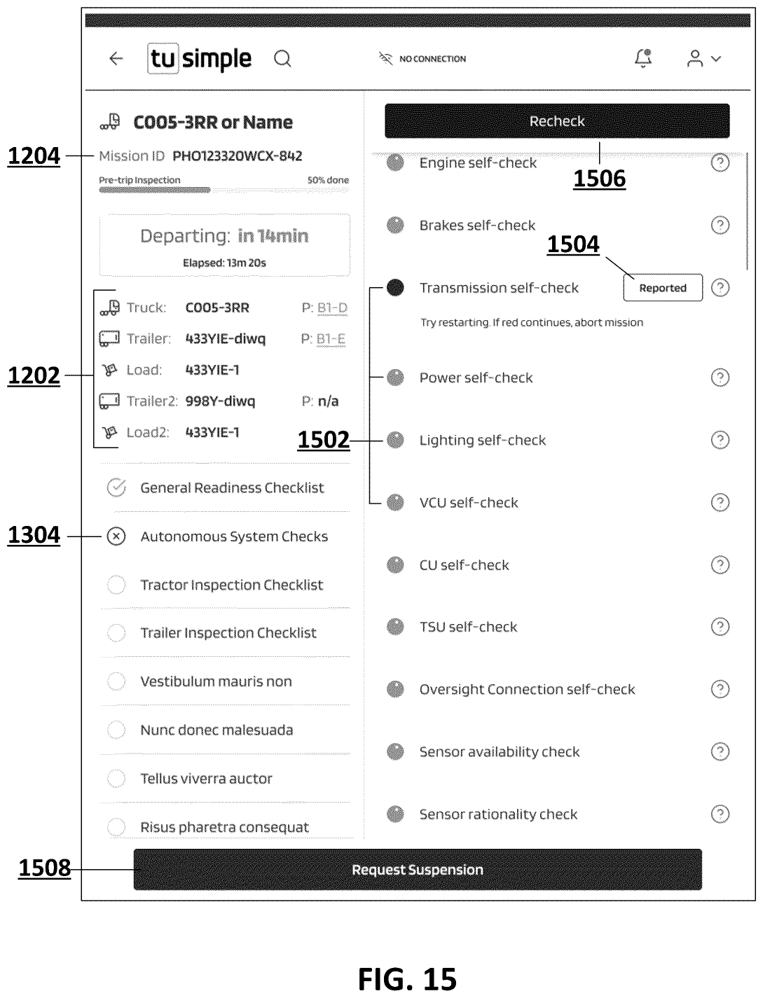

FIG. 15 is an operational example of a dynamic inspection task checklist associated with an automated self-check protocol comprising one or more automated diagnostic procedures related to an AV 102 in accordance with some embodiments discussed herein. Specifically, FIG. 15 illustrates an autonomous system checklist 1304 that is in progress. In various embodiments, the AV inspection system 802 can cause an AV 102 to execute a dynamic inspection task checklist (e.g., autonomous system checklist 1304) associated with an automated self-check protocol. A user computing device 702 associated with a vehicle inspector profile that is associated with the AV inspection system 802 can direct, via a communications network (e.g., network 104), an in-vehicle control computer 202 aboard an AV 102 to execute one or more automated diagnostic procedures. The one or more automated diagnostic procedures can cause one or more components associated with one or more respective AV subsystems 212 to automatically execute various self-checks configured to test the operational capacities of the one or more AV subsystem components.

An automatic self-check protocol can direct the in-vehicle control computer 202 to cause the one or more AV subsystem components to execute automated diagnostic procedures such as, but not limited to, automatic power cycling of the AV subsystem components, automatic engagement of the AV subsystem components, various stress-tests associated with the AV subsystem components, various network connectivity tests associated with the AV subsystem components, various sensor data collection tests, and/or the like. The AV inspection system 802 can determine whether the respective AV subsystem components satisfy a respective predetermined performance threshold during the execution of the automated diagnostic procedures. Based on the outcomes of the automated diagnostic procedures, the AV inspection system 802 can indicate whether the one or more AV subsystem components have passed or failed the self-checks on an interactive inspection interface 902 of a user computing device 702 associated with an inspector profile.

For example, interactive display elements such as the interactive display elements 1502 and 1504 can visually indicate that the AV inspection system 802 has determined that one or more automated diagnostic procedures associated with one or more respective AV subsystem components have passed or failed. For instance, the interactive display element 1502 indicates that an automated diagnostic procedure associated with the transmission associated the AV 102 has failed. In some embodiments, when an automated diagnostic procedure has failed, the AV inspection system can automatically transmit an inspection task issue report to one or more designated user profiles (e.g., an administrator profile) and/or the operation server 106.

The AV inspection system 802 is also configured to recheck a particular component of a respective AV subsystem. For example, in response to an interaction with an interactive display element 1506 (rendered here as an interactive button), the AV inspection system 802 can issue a recheck command to the in-vehicle control computer 202 associated with the AV 102. The recheck command transmitted by the AV inspection system 802 can cause the in-vehicle control computer 202 to initiate and/or repeat one or more automated diagnostic procedures corresponding to one or more AV subsystem components.

Based on the results of the automated self-check protocol comprising the one or more automated diagnostic procedures related to the AV 102, the AV inspection system 802 can transmit a suspension signal associated with the AV 102 to the operation server 106 when the automated self-check protocol has failed. In some embodiments, the suspension signal associated with the AV 102 can be automatically transmitted to the operation server 106. In various other embodiments, the suspension signal associated with the AV 102 can be transmitted to the operation server 106 based on an interaction with an interactive display element such as interactive display element 1508 rendered as an interactive button on the interactive inspection interface 902 associated with a particular user computing device 702. Additionally or alternatively, in some embodiments, the AV inspection system 802 can automatically transmit a hard-stop command to an in-vehicle control computer 202 associated with the respective AV 102 that has failed one or more automated diagnostic procedures associated with a particular automated self-check protocol. In various other embodiments, the hard-stop command can be transmitted to an in-vehicle control computer 202 associated with the respective AV 102 by the operation server 106 in response to receiving the suspension signal transmitted by the AV inspection system 802.

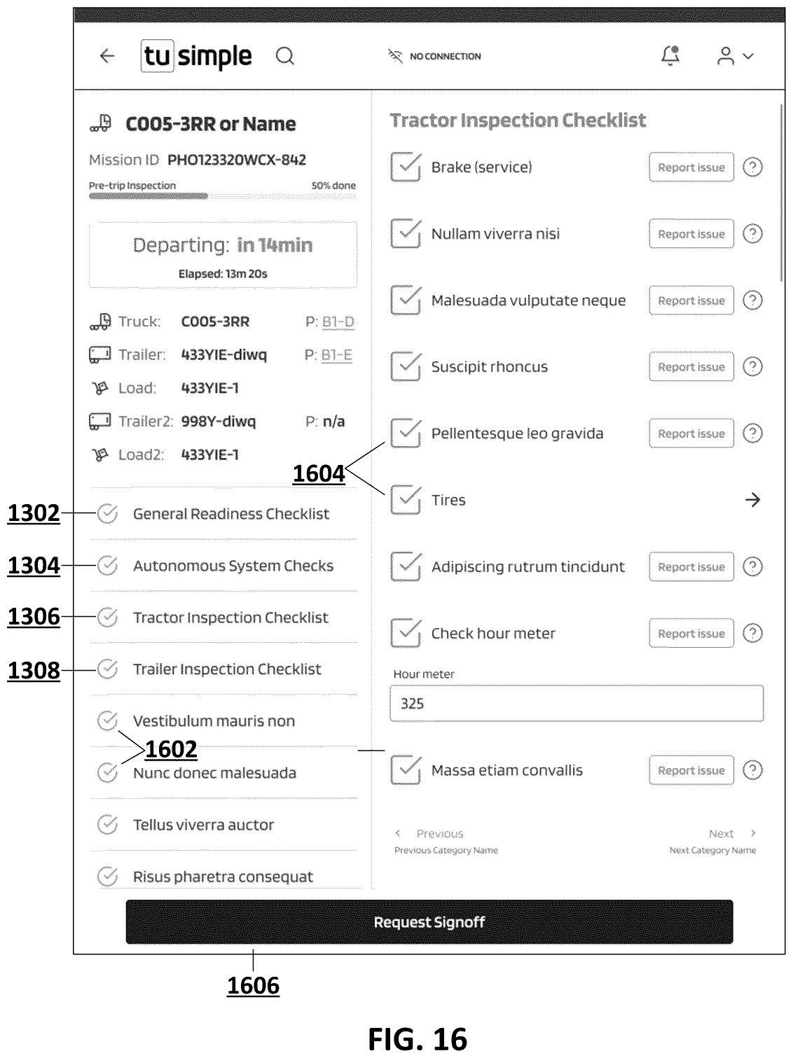

FIG. 16 is an operational example of a plurality of successfully completed dynamic inspection task checklists 1302-1308 in accordance with some embodiments discussed herein. Various interactive display elements 1602-1604 can indicate that the various AV inspection tasks associated with the various respective dynamic inspection task checklists 1302-1308 associated to an AV 102 have been completed successfully.

In some embodiments, upon successful completion of one or more dynamic inspection task checklists (e.g., dynamic inspection task checklists 1302-1308), the AV inspection system 802 can automatically transmit a signoff request to the operation server 106, where the signoff request is associated with the respective AV 102. The AV inspection system 802 is configured to receive a signoff approval signal from the operation server 106 associated with the signoff request. The signoff approval signal can be a signal certifying that the respective AV 102 is capable of transitioning into an autonomous driving mode. In some embodiments, the AV inspection system 802 can automatically deploy the respective AV to a next destination in response to receiving the signoff approval signal from the operation server 106.

In various other embodiments, the AV inspection system 802 can transmit a signoff request to the operation server 106 in response to an interaction with the interactive display element 1606 rendered on the interactive inspection interface 902 of a particular user computing device 702. In one or more embodiments, the interactive display element 1606 is only enabled upon successful completion of all the dynamic inspection task checklists 1302-1308 such that the interactive display element 1606 is inoperable and/or hidden from view until the dynamic inspection task checklists 1302-1308 have been successfully completed.

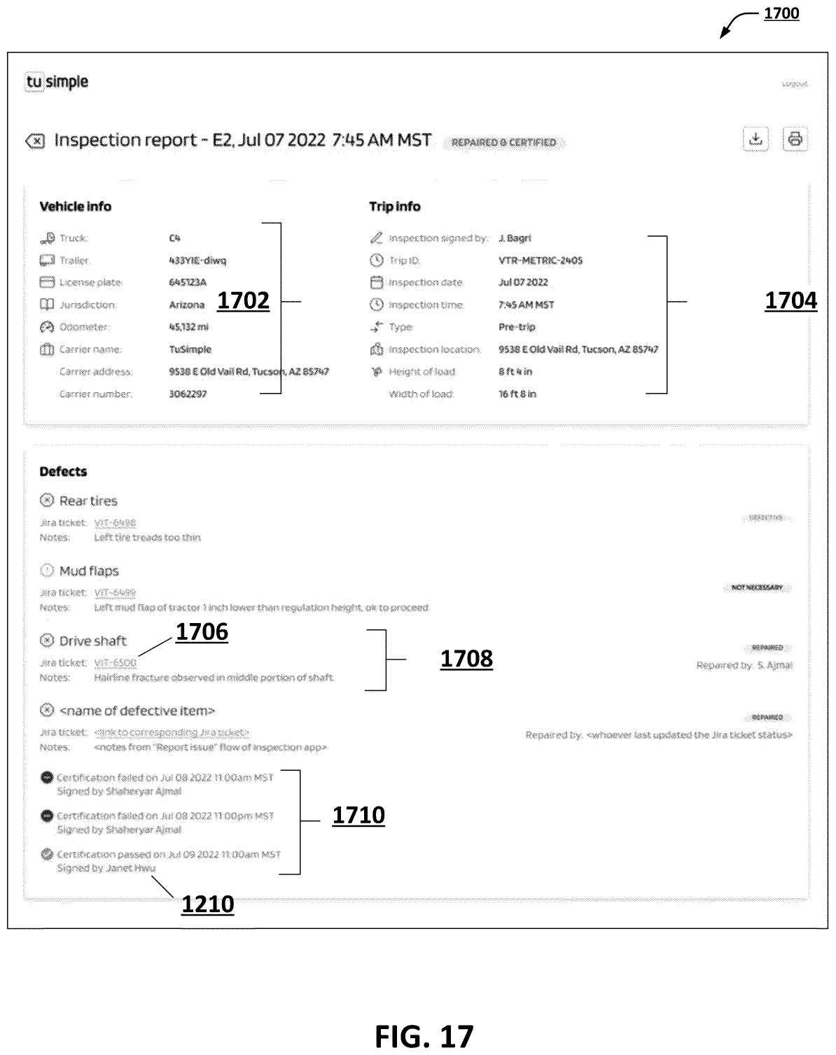

FIG. 17 is an operational example of an interactive post-inspection report 1700 in accordance with some embodiments discussed herein. The AV inspection system 802 is configured to generate one or more interactive post-inspection reports summarizing the various dynamic inspection task checklists completed in relation to a particular AV 102. For example, the AV inspection system 802 can compile and organize an interactive post-inspection report 1700 associated with a particular AV 102 and transmit the interactive post-inspection report 1700 to the operation server 106 and/or an application server 328 associated with the enterprise responsible for the AV 102.

Additionally, the AV inspection system 802 can generate documentation based on the interactive post-inspection report 1700 that describes how the AV 102 is in compliance with various safety standards and regulations. For instance, the AV inspection system 802 can generate one or more post-inspection audit reports based on the interactive post-inspection report. In the event that highway patrol and/or safety personnel need to weigh, inspect, and/or otherwise engage the AV 102, the post-inspection audit report can provide the necessary documentation needed to demonstrate that the AV 102 is in compliance with local safety standards and regulations.

The AV inspection system 802 can generate one or more interactive post-inspection reports based on a user role associated with a respective user profile and, as such, the AV inspection system 802 can generate one or more respective post-inspection audit reports based on the one or more interactive post-inspection reports that were generated based on the user role.

In various embodiments, the interactive post-inspection report 1700 can comprise various identifying information related to the AV 102, inspection data, the current mission data associated with the AV 102, and/or one or more user profiles associated with the dynamic inspection task checklists that the interactive post-inspection report 1700 is based upon. For example, AV identification data 1702 comprises data related to a truck ID, a trailer ID, a license plate number, an operational jurisdiction, an odometer reading, a carrier name, a carrier address, and/or a carrier number associated with the AV 102. Inspection data 1704 comprises data related to an inspector signature associated with a user profile, a trip ID, an inspection date, an inspection time, an inspection type, an inspection location, a load height, and/or a load width associated with the AV 102. In one or more embodiments, one or more portions of data comprised within the interactive post-inspection can be comprised in the AV fleet data 622.

In one or more embodiments, details related to any inspection task issue reports generated via the inspection task issue reporting interface 1400 can be listed on a corresponding interactive post-inspection report 1700. For example, inspection task issue report details 1708 comprising notes generated by a vehicle inspector regarding the respective AV subsystem component that failed inspection can be compiled in the interactive post-inspection report 1700. Inspection task issue report details 1708 can include, but are not limited to, an AV subsystem component name, an interactive display element 1706 associated with a respective maintenance e-ticket, an inspection task issue report description, a repair status, and/or a user profile identifier associated with a maintenance engineer who repaired the respective AV subsystem component that failed inspection.

The AV inspection system 802 can be integrated with an AV maintenance and repair ticketing system associated with a particular enterprise managing an AV fleet. In various embodiments, upon the submission of an inspection task issue report, the AV maintenance and repair ticketing system can automatically perform or schedule maintenance, such as by generating a maintenance e-ticket for the AV subsystem component for which the inspection task issue report has been generated. In various embodiments, an interaction with the interactive display element 1706 associated with a respective maintenance e-ticket can cause the rendering of a maintenance ticketing interface associated with the AV maintenance and repair ticketing system. In some embodiments, details related to the repair and/or maintenance corresponding to the AV subsystem component that failed inspection can be displayed on the maintenance ticketing interface associated with the AV maintenance and repair ticketing system.

In various embodiments, the interactive post-inspection report 1700 can comprise inspector certification data O10. The inspector certification data O10 can comprise data describing whether a particular AV 102 passed inspection and/or has been certified as passing inspection by a vehicle inspector associated with a user profile. The inspector certification data O10 can comprise certification timestamp data as well as a user profile identifier 1210 associated with the respective vehicle inspector who signed off on one or more dynamic inspection task checklists associated with the particular AV 102.

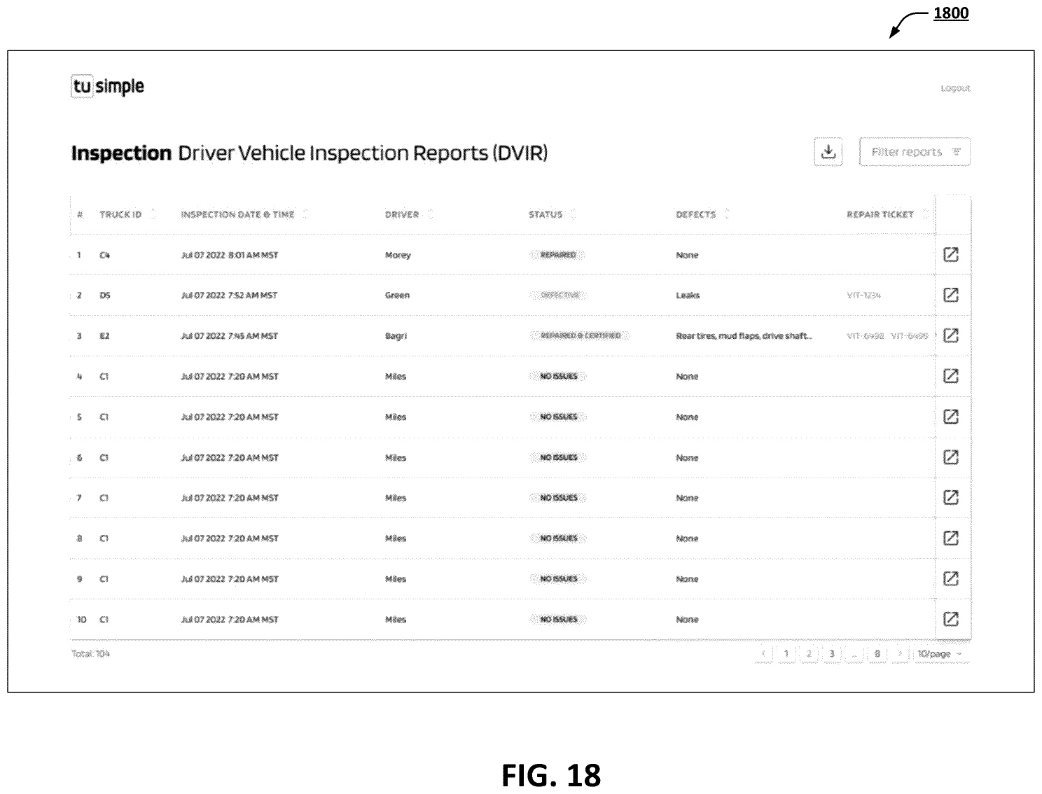

FIG. 18 is an operational example of an interactive post-inspection report table 1800 associated with a plurality of AVs 102 in accordance with some embodiments discussed herein. In various embodiments, the AV inspection system 802 can generate an interactive post-inspection report table 1800 comprising one or more respective interactive post-inspection reports 1700 associated with one or more AVs 102 that are inbound and/or outbound from a particular AV travel hub. Alternatively, the AV inspection system 802 can be configured to generate the interactive post-inspection report table 1800 for an entire AV fleet associated with a particular enterprise.

The interactive post-inspection report table 1800 can be configured to display one or more portions of data related to, but not limited by, a truck ID, an inspection date and time, a driver ID, a current inspection status, a brief description of issues, and/or one or more maintenance e-tickets associated with one or more interactive post-inspection reports 1700 that are associated with one or more respective AVs 102. In various embodiments, the AV inspection system 802 can filter, sort, and/or export the one or more interactive post-inspection reports associated with the interactive post-inspection report table 1800.

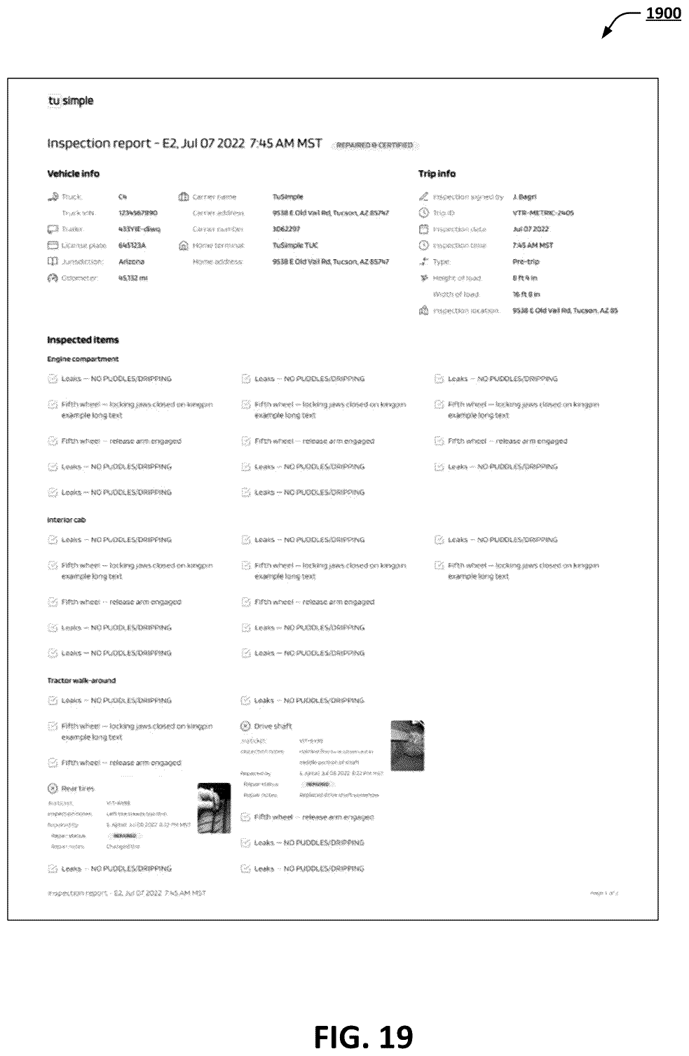

FIG. 19 is an operational example of a post-inspection audit report 1900 generated based on an interactive post-inspection report 1700 in accordance with some embodiments discussed herein. The AV inspection system 802 can generate documentation based on the interactive post-inspection report 1700 that describes how the AV 102 is in compliance with various safety standards and regulations. For instance, the AV inspection system 802 can generate one or more post-inspection audit reports 1900 based on the interactive post-inspection report 1800. In the event that highway patrol and/or safety personnel need to weigh, inspect, and/or otherwise engage the AV 102, the post-inspection audit report can provide the necessary documentation needed to demonstrate that the AV 102 is in compliance with local safety standards and regulations.

The post-inspection audit report 1900 can comprise one or more portions of data associated with the respective interactive post-inspection report 1800. The post-inspection audit report 1900 can be generated based on one or more user profiles and/or user roles such that only data (e.g., inspection data and/or or mission data) that is relevant to the one or more user profiles is compiled into the post-inspection audit report 1900. In circumstances in which a user computing device 702 is associated with a particular user profile and/or a particular user role that does not have the access permissions necessary to access an interactive post-inspection report 1800, the user computing device 702 can render a version of the post-inspection audit report 1900 comprising data that is relevant for a user profile and/or user role.

In one or more embodiments, the post-inspection audit report 1900 can be uploaded to an electronic travel logging device associated with the AV 102. Additionally or alternatively, the AV inspection system 802 can transmit the post-inspection audit report 1900 to the in-vehicle control computer 202 associated with the AV 102 to be stored in a non-transitory memory device such as the data storage 210. In various embodiments, electronic versions of the post-inspection audit report 1900 can be rendered on one or more electronic visual displays associated with the AV 102 such that one or more third-party personnel (e.g., law enforcement and/or road safety personnel) can easily view the post-inspection audit report 1900.

In various embodiments, the post-inspection audit report 1900 can be a summary of one or more dynamic inspection task checklists executed for a corresponding AV 102. The post-inspection audit report 1900 can detail which AV subsystem components passed or failed inspection. Likewise, data related to any repair work executed in response to one or more failed AV inspection tasks can be documented by the post-inspection audit report 1900. In various embodiments, any image data captured by a user computing device 702 and submitted in an inspection task issue report generated by the inspection task issue reporting interface 1400 can be compiled into the post-inspection audit report 1900.

In general, methods, apparatus, systems, computing devices, computing entities, and/or the like are therefore provided for performing in-depth inspections of one or more autonomous vehicles (AVs) associated with an AV fleet related to a particular enterprise operating within an autonomous vehicle network. For example, certain embodiments of the present disclosure utilize systems, methods, and computer program products for inspecting one or more AVs utilizing dynamic inspection task checklists in order to certify that the one or more AVs are capable of operating in an autonomous driving mode on public streets and highways while remaining in compliance with federal safety standards and regulations.

FIGS. 10 and 11 illustrate operations of an apparatus, method and computer program product according to some example embodiments. It will be understood that each operation of the flowchart or diagram, and combinations of operations in the flowchart or diagram, may be implemented by various means, such as hardware and/or a computer program product comprising one or more computer-readable mediums having computer readable program instructions stored thereon. For example, one or more of the procedures described herein, such as in conjunction with FIG. 7, may be embodied by computer program instructions of a computer program product. In this regard, the computer program product(s) which embody the procedures described herein may comprise one or more memory devices storing instructions executable by a processor. In some example embodiments, the computer program instructions of the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s). The computer program instructions of one or more computer program products may also be loaded onto a computer or other programmable apparatus (for example, control system 32 and/or other apparatus) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

Clause 1. An apparatus comprising at least one processor and at least one non-transitory memory including computer program code instructions, the computer program code instructions configured to, when executed, cause the apparatus to:
generate, based on a user profile, one or more dynamic inspection task checklists for a respective autonomous vehicle (AV) of one or more AVs in an AV fleet based on a first enterprise-defined task protocol, wherein the one or more dynamic inspection task checklists are associated with one or more respective AV subsystems, and wherein the user profile is associated with a respective user role such that the one or more dynamic inspection task checklists differ dependent upon the respective user role; and cause the one or more dynamic inspection task checklists to be rendered via an interactive inspection interface of a user computing device associated with the user profile such that one or more respective inspection tasks comprised in the one or more dynamic inspection task checklists are interactive.

Clause 2. The apparatus of Clause 1 wherein the user role associated with the user profile is at least one of a maintenance role, an inspection role, an operator role, a client role, an administrative role, a regulatory role, or a law enforcement role, and wherein the one or more dynamic inspection checklists are configured based in part on the user role associated with the user profile.

Clause 3. The computer program code instructions are further configured to cause the apparatus of Clause 1 to:
upon completion of the one or more dynamic inspection task checklists, generate one or more interactive post-inspection reports, wherein the one or more interactive post-inspection reports are configured based in part on the user role associated with the user profile, and wherein the one or more interactive post-inspection reports describes a passing or a failure of the one or more respective AV subsystems associated with the respective AV of the one or more AVs.

Clause 4. The computer program code instructions are further configured to cause the apparatus of Clause 3 to:
generate, based on the one or more interactive post-inspection reports, one or more respective post-inspection audit reports, wherein the one or more post-inspection audit reports describe compliance of the respective AV to one or more vehicle safety and regulatory standards.

Clause 5. The computer program code instructions are further configured to cause the apparatus of Clause 1 to:
upon successful completion of the one or more dynamic inspection task checklists, transmit a signoff request to an operation server, wherein the signoff request is associated with the respective AV of the one or more AVs; and
in response to receiving a signoff approval signal associated with the signoff request:
certify that the respective AV is capable of transitioning into an autonomous driving mode; and
deploy the respective AV to a next destination, wherein data related to the next destination is comprised within mission data associated with the AV.

Clause 6. The apparatus of Clause 1 wherein the one or more dynamic inspection task checklists are generated based in part on one or more portions of AV fleet data, wherein the one or more portions of AV fleet data comprises data related to at least one of AV mission data, AV location data, AV identification data, AV logistics data, AV payload data, AV health data, or AV safety compliance data.

Clause 7. A computer-implemented method comprises:
generating, based on a user profile, one or more dynamic inspection task checklists for a respective autonomous vehicle (AV) of one or more AVs in an AV fleet based on a first enterprise-defined task protocol, wherein the one or more dynamic inspection task checklists are associated with one or more respective AV subsystems, and wherein the user profile is associated with a respective user role such that the one or more dynamic inspection task checklists differ dependent upon the respective user role; and
causing the one or more dynamic inspection task checklists to be rendered via an interactive inspection interface of a user computing device associated with the user profile such that one or more respective inspection tasks comprised in the one or more dynamic inspection task checklists are interactive.

Clause 8. The computer-implemented method of Clause 7 wherein the user role associated with the user profile can be at least one of a maintenance role, an inspection role, an operator role, a client role, an administrative role, a regulatory role, or a law enforcement role, and wherein the one or more dynamic inspection checklists are configured based in part on the user role associated with the user profile.

Clause 9. The computer-implemented method of Clause 7 further comprising:
upon completion of the one or more dynamic inspection task checklists, generating one or more interactive post-inspection reports, wherein the one or more interactive post-inspection reports are configured based in part on the user role associated with the user profile, and wherein the one or more interactive post-inspection reports describes a passing or a failure of the one or more respective AV subsystems associated with the respective AV of the one or more AVs.

Clause 10. The computer-implemented method of the third embodiment further comprises:
generating, based on the one or more interactive post-inspection reports, one or more respective post-inspection audit reports, wherein the one or more post-inspection audit reports describe compliance of the respective AV to one or more vehicle safety and regulatory standards.

Clause 11. The computer-implemented method of Clause 7 further comprising:
upon successful completion of the one or more dynamic inspection task checklists, transmitting a signoff request to an operation server, wherein the signoff request is associated with the respective AV of the one or more AVs; and
in response to receiving a signoff approval signal associated with the signoff request:
certifying that the respective AV is capable of transitioning into an autonomous driving mode; and
deploying the respective AV to a next destination, wherein data related to the next destination is comprised within mission data associated with the AV.

Clause 12. The computer-implemented method of Clause 7 wherein the one or more dynamic inspection task checklists are generated based in part on one or more portions of AV fleet data, wherein the one or more portions of AV fleet data comprises data related to at least one of AV mission data, AV location data, AV identification data, AV logistics data, AV payload data, AV health data, or AV safety compliance data.

Clause 13. A computer program product comprising at least one non-transitory computer-readable storage medium having computer-executable program code instructions stored therein, the computer-executable program code instructions comprising program code instructions configured to:
generate, based on a user profile, one or more dynamic inspection task checklists for a respective autonomous vehicle (AV) of one or more AVs in an AV fleet based on a first enterprise-defined task protocol, wherein the one or more dynamic inspection task checklists are associated with one or more respective AV subsystems, and wherein the user profile is associated with a respective user role such that the one or more dynamic inspection task checklists differ dependent upon the respective user role; and
cause the one or more dynamic inspection task checklists to be rendered via an interactive inspection interface of a user computing device associated with the user profile such that one or more respective inspection tasks comprised in the one or more dynamic inspection task checklists are interactive.

Clause 14. The computer program product of Clause 13 wherein the user role associated with the user profile can be at least one of a maintenance role, an inspection role, an operator role, a client role, an administrative role, a regulatory role, or a law enforcement role, and wherein the one or more dynamic inspection checklists are configured based in part on the user role associated with the user profile.

Clause 15. The program code instructions of the computer program product of Clause 13 being further configured to:
upon completion of the one or more dynamic inspection task checklists, generate one or more interactive post-inspection reports, wherein the one or more interactive post-inspection reports are configured based in part on the user role associated with the user profile, and wherein the one or more interactive post-inspection reports describes a passing or a failure of the one or more respective AV subsystems associated with the respective AV of the one or more AVs.

Clause 16. The program code instructions of the computer program product of Clause 15 being further configured to:
generate, based on the one or more interactive post-inspection reports, one or more respective post-inspection audit reports, wherein the one or more post-inspection audit reports describe compliance of the respective AV to one or more vehicle safety and regulatory standards.

Clause 17. The program code instructions of the computer program product of Clause 13 being further configured to:
upon successful completion of the one or more dynamic inspection task checklists, transmit a signoff request to an operation server, wherein the signoff request is associated with the respective AV of the one or more AVs; and
in response to receiving a signoff approval signal associated with the signoff request:
certify that the respective AV is capable of transitioning into an autonomous driving mode; and
deploy the respective AV to a next destination, wherein data related to the next destination is comprised within mission data associated with the AV.

Clause 18. The computer program product of the computer program product of Clause 13 wherein the one or more dynamic inspection task checklists are generated based in part on one or more portions of AV fleet data, wherein the one or more portions of AV fleet data comprises data related to at least one of AV mission data, AV location data, AV identification data, AV logistics data, AV payload data, AV health data, or AV safety compliance data.

Clause 19. An apparatus comprising at least one processor and at least one non-transitory memory including computer program code instructions, the computer program code instructions configured to, when executed, cause the apparatus to:
generate one or more dynamic inspection task checklists for a respective autonomous vehicle (AV) of one or more AVs in an AV fleet based on a first enterprise-defined task protocol, wherein the one or more dynamic inspection task checklists are associated with one or more respective AV subsystems;
cause the one or more dynamic inspection task checklists to be rendered via an interactive inspection interface such that one or more respective inspection tasks comprised in the one or more dynamic inspection task checklists are interactive;
initiate, based on information provided by the interactive inspection interface, an automated self-check protocol associated with the respective AV, wherein initializing the automated self-check protocol causes an in-vehicle control computer associated with the respective AV to execute one or more automated diagnostic procedures to ensure nominal function of one or more respective components of the one or more AV subsystems;
determine, based in part on the automated self-check protocol, whether the respective AV is certified to transition into an autonomous driving mode; and
in response to determining that the respective AV is certified to transition into the autonomous driving mode, deploy the respective AV to a next destination, wherein the next destination is determined based in part on the AV fleet data.

Clause 20. The apparatus of Clause 19 wherein the first enterprise-defined task protocol is based on a first configuration of inspection task data objects corresponding to one or more respective inspection tasks associated with the one or more AV subsystems.

Clause 21. The computer program code instructions are further configured to cause the apparatus of Clause 19 to:
generate one or more dynamic inspection task checklists for one or more respective AVs based on a second enterprise-defined task protocol, wherein the second enterprise-defined task protocol is based on a second configuration of inspection task data objects corresponding to one or more respective inspection tasks associated with the one or more AV subsystems.

Clause 22. The computer program code instructions are further configured to cause the apparatus of Clause 19 to:
generate, based on at least one completed dynamic inspection task checklist of the one or more dynamic inspection task checklists, one or more interactive post-inspection reports, wherein the one or more interactive post-inspection reports describes a passing or a failure of the one or more respective AV subsystems associated with the respective AV.

Clause 23. The computer program code instructions are further configured to cause the apparatus of Clause 22 to:
generate, based on the one or more interactive post-inspection reports, one or more post-inspection audit reports associated with the respective AV, wherein the one or more post-inspection audit reports describe compliance of the respective AV to one or more vehicle safety and regulatory standards.

Clause 24. The computer program code instructions are further configured to cause the apparatus of Clause 19 to:
in response to determining the respective AV is not certified to transition into the autonomous driving mode:
transmit, to the operational server system, a suspension signal associated with the respective AV, wherein the suspension signal comprises an indication of one or more critical failures associated with the one or more respective AV subsystems; and
transmit, to the in-vehicle control computer associated with the respective AV, a hard-stop command such that the respective AV can no longer operate in the autonomous driving mode until the one or more critical failures have been corrected.

Clause 25. The computer program code instructions are further configured to cause the apparatus of Clause 19 to:
capture image data associated with the one or more respective inspection tasks comprised in the one or more dynamic inspection task checklists.

Clause 26 The apparatus of Clause 19 wherein the one or more dynamic inspection task checklists are generated based in part on one or more portions of AV fleet data, wherein the one or more portions of AV fleet data comprises data related to at least one of AV mission data, AV location data, AV identification data, AV logistics data, AV payload data, AV health data, or AV safety compliance data.

Clause 27. A computer-implemented method is provided that comprises:
generating one or more dynamic inspection task checklists for a respective autonomous vehicle (AV) of one or more AVs in an AV fleet based on a first enterprise-defined task protocol, wherein the one or more dynamic inspection task checklists are associated with one or more respective AV subsystems;
causing the one or more dynamic inspection task checklists to be rendered via an interactive inspection interface such that one or more respective inspection tasks comprised in the one or more dynamic inspection task checklists are interactive;
initiating, based on information provided by the interactive inspection interface, an automated self-check protocol associated with the respective AV, wherein initializing the automated self-check protocol causes an in-vehicle control computer associated with the respective AV to execute one or more automated diagnostic procedures to ensure nominal function of one or more respective components of the one or more AV subsystems;
determining, based in part on the automated self-check protocol, whether the respective AV is certified to transition into an autonomous driving mode; and
in response to determining that the respective AV is certified to transition into the autonomous driving mode, deploying the respective AV to a next destination, wherein the next destination is determined based in part on the AV fleet data.

Clause 28. The computer-implemented method of Clause 27 wherein the first enterprise-defined task protocol is based on a first configuration of inspection task data objects corresponding to one or more respective inspection tasks associated with the one or more AV subsystems.

Clause 29. The computer-implemented method of Clause 27 further comprising:
generating one or more dynamic inspection task checklists for one or more respective AVs based on a second enterprise-defined task protocol, wherein the second enterprise-defined task protocol is based on a second configuration of inspection task data objects corresponding to one or more respective inspection tasks associated with the one or more AV subsystems.

Clause 30. The computer-implemented method of Clause 27 further comprising:
generating, based on at least one completed dynamic inspection task checklist of the one or more dynamic inspection task checklists, one or more interactive post-inspection reports, wherein the one or more interactive post-inspection reports describes a passing or a failure of the one or more respective AV subsystems associated with the respective AV.

Clause 31. The computer-implemented method of Clause 30 further comprising:
generating, based on the one or more interactive post-inspection reports, one or more post-inspection audit reports associated with the respective AV, wherein the one or more post-inspection audit reports describe compliance of the respective AV to one or more vehicle safety and regulatory standards.

Clause 32. The computer-implemented method of Clause 27 further comprising:
in response to determining the respective AV is not certified to transition into the autonomous driving mode:
transmitting, to the operational server system, a suspension signal associated with the respective AV, wherein the suspension signal comprises an indication of one or more critical failures associated with the one or more respective AV subsystems; and
transmitting, to the in-vehicle control computer associated with the respective AV, a hard-stop command such that the respective AV can no longer operate in the autonomous driving mode until the one or more critical failures have been corrected.

Clause 33. The computer-implemented method of Clause 27 further comprising:
capturing image data associated with the one or more respective inspection tasks comprised in the one or more dynamic inspection task checklists.

Clause 34. The computer-implemented method of Clause 27 wherein the one or more dynamic inspection task checklists are generated based in part on one or more portions of AV fleet data, wherein the one or more portions of AV fleet data comprises data related to at least one of AV mission data, AV location data, AV identification data, AV logistics data, AV payload data, AV health data, or AV safety compliance data.

Clause 35. A computer program product comprising at least one non-transitory computer-readable storage medium having computer-executable program code instructions stored therein, the computer-executable program code instructions comprising program code instructions configured to:
generate one or more dynamic inspection task checklists for a respective autonomous vehicle (AV) of one or more AVs in an AV fleet based on a first enterprise-defined task protocol, wherein the one or more dynamic inspection task checklists are associated with one or more respective AV subsystems;
cause the one or more dynamic inspection task checklists to be rendered via an interactive inspection interface such that one or more respective inspection tasks comprised in the one or more dynamic inspection task checklists are interactive;
initiate, based on information provided by the interactive inspection interface, an automated self-check protocol associated with the respective AV, wherein initializing the automated self-check protocol causes an in-vehicle control computer associated with the respective AV to execute one or more automated diagnostic procedures to ensure nominal function of one or more respective components of the one or more AV subsystems;
determine, based in part on the automated self-check protocol, whether the respective AV is certified to transition into an autonomous driving mode; and
in response to determining that the respective AV is certified to transition into the autonomous driving mode, deploy the respective AV to a next destination, wherein the next destination is determined based in part on the AV fleet data.

Clause 36. The computer program product of Clause 35 wherein the first enterprise-defined task protocol is based on a first configuration of inspection task data objects corresponding to one or more respective inspection tasks associated with the one or more AV subsystems.

Clause 37. The program code instructions of the computer program product of Clause 35 being further configured to:
generate one or more dynamic inspection task checklists for one or more respective AVs based on a second enterprise-defined task protocol, wherein the second enterprise-defined task protocol is based on a second configuration of inspection task data objects corresponding to one or more respective inspection tasks associated with the one or more AV subsystems.

Clause 38. The program code instructions of the computer program product of Clause 35 being further configured to:
generate, based on at least one completed dynamic inspection task checklist of the one or more dynamic inspection task checklists, one or more interactive post-inspection reports, wherein the one or more interactive post-inspection reports describes a passing or a failure of the one or more respective AV subsystems associated with the respective AV.

Clause 39. The program code instructions of the computer program product of Clause 38 being further configured to:
generate, based on the one or more interactive post-inspection reports, one or more post-inspection audit reports associated with the respective AV, wherein the one or more post-inspection audit reports describe compliance of the respective AV to one or more vehicle safety and regulatory standards.

Clause 40. The program code instructions of the computer program product of Clause 35 being further configured to:
in response to determining the respective AV is not certified to transition into the autonomous driving mode:
transmit, to the operational server system, a suspension signal associated with the respective AV, wherein the suspension signal comprises an indication of one or more critical failures associated with the one or more respective AV subsystems; and
transmit, to the in-vehicle control computer associated with the respective AV, a hard-stop command such that the respective AV can no longer operate in the autonomous driving mode until the one or more critical failures have been corrected.

Clause 41. The program code instructions of the computer program product of Clause 35 being further configured to:
capture image data associated with the one or more respective inspection tasks comprised in the one or more dynamic inspection task checklists.

Clause 42. The computer program product of Clause 35 wherein the one or more dynamic inspection task checklists are generated based in part on one or more portions of AV fleet data, wherein the one or more portions of AV fleet data comprises data related to at least one of AV mission data, AV location data, AV identification data, AV logistics data, AV payload data, AV health data, or AV safety compliance data.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one non-transitory memory including computer program code instructions, the computer program code instructions configured to, when executed, cause the apparatus to:
generate, based on a user profile, one or more dynamic inspection task checklists for a respective autonomous vehicle (AV) of one or more AVs in an AV fleet based on a first enterprise-defined task protocol, wherein the one or more dynamic inspection task checklists are associated with one or more respective AV subsystems, and wherein the user profile is associated with a respective user role such that the one or more dynamic inspection task checklists differ dependent upon the respective user role; and
cause the one or more dynamic inspection task checklists to be rendered via an interactive inspection interface of a user computing device associated with the user profile such that one or more respective inspection tasks comprised in the one or more dynamic inspection task checklists are interactive.

2. The apparatus of claim 1, wherein the user role associated with the user profile can be at least one of a maintenance role, an inspection role, an operator role, a client role, an administrative role, a regulatory role, or a law enforcement role, and wherein the one or more dynamic inspection checklists are configured based in part on the user role associated with the user profile.

3. The apparatus of claim 1, wherein the computer program code instructions are further configured to cause the apparatus to:
upon completion of the one or more dynamic inspection task checklists, generate one or more interactive post-inspection reports, wherein the one or more interactive post-inspection reports are configured based in part on the user role associated with the user profile, and wherein the one or more interactive post-inspection reports describes a passing or a failure of the one or more respective AV subsystems associated with the respective AV of the one or more AVs.

4. The apparatus of claim 3, wherein the computer program code instructions are further configured to cause the apparatus to:
generate, based on the one or more interactive post-inspection reports, one or more respective post-inspection audit reports, wherein the one or more post-inspection audit reports describe compliance of the respective AV to one or more vehicle safety and regulatory standards.

5. The apparatus of claim 1, wherein the computer program code instructions are further configured to cause the apparatus to:
upon successful completion of the one or more dynamic inspection task checklists, transmit a signoff request to an operation server, wherein the signoff request is associated with the respective AV of the one or more AVs; and
in response to receiving a signoff approval signal associated with the signoff request:
certify that the respective AV is capable of transitioning into an autonomous driving mode; and
deploy the respective AV to a next destination, wherein data related to the next destination is comprised within mission data associated with the AV.

6. The apparatus of claim 1, wherein the one or more dynamic inspection task checklists are generated based in part on one or more portions of AV fleet data, and wherein the one or more portions of AV fleet data comprises data related to at least one of AV mission data, AV location data, AV identification data, AV logistics data, AV payload data, AV health data, or AV safety compliance data.

7. A computer-implemented method, the method comprising:
generating, based on a user profile, one or more dynamic inspection task checklists for a respective autonomous vehicle (AV) of one or more AVs in an AV fleet based on a first enterprise-defined task protocol, wherein the one or more dynamic inspection task checklists are associated with one or more respective AV subsystems, and wherein the user profile is associated with a respective user role such that the one or more dynamic inspection task checklists differ dependent upon the respective user role; and
causing the one or more dynamic inspection task checklists to be rendered via an interactive inspection interface of a user computing device associated with the user profile such that one or more respective inspection tasks comprised in the one or more dynamic inspection task checklists are interactive.

8. The computer-implemented method of claim 7, wherein the user role associated with the user profile can be at least one of a maintenance role, an inspection role, an operator role, a client role, an administrative role, a regulatory role, or a law enforcement role, and wherein the one or more dynamic inspection checklists are configured based in part on the user role associated with the user profile.

9. The computer-implemented method of claim 7, the method further comprising:
upon completion of the one or more dynamic inspection task checklists, generating one or more interactive post-inspection reports, wherein the one or more interactive post-inspection reports are configured based in part on the user role associated with the user profile, and wherein the one or more interactive post-inspection reports describes a passing or a failure of the one or more respective AV subsystems associated with the respective AV of the one or more AVs.

10. The computer-implemented method of claim 9, the method further comprising:
generating, based on the one or more interactive post-inspection reports, one or more respective post-inspection audit reports, wherein the one or more post-inspection audit reports describe compliance of the respective AV to one or more vehicle safety and regulatory standards.

11. The computer-implemented method of claim 7, the method further comprising:
upon successful completion of the one or more dynamic inspection task checklists, transmitting a signoff request to an operation server, wherein the signoff request is associated with the respective AV of the one or more AVs; and
in response to receiving a signoff approval signal associated with the signoff request:
certifying that the respective AV is capable of transitioning into an autonomous driving mode; and
deploying the respective AV to a next destination, wherein data related to the next destination is comprised within mission data associated with the AV.

12. The computer-implemented method of claim 7, wherein the one or more dynamic inspection task checklists are generated based in part on one or more portions of AV fleet data, and wherein the one or more portions of AV fleet data comprises data related to at least one of AV mission data, AV location data, AV identification data, AV logistics data, AV payload data, AV health data, or AV safety compliance data.

13. An apparatus comprising at least one processor and at least one non-transitory memory including computer program code instructions, the computer program code instructions configured to, when executed, cause the apparatus to:
generate one or more dynamic inspection task checklists for a respective autonomous vehicle (AV) of one or more AVs in an AV fleet based on a first enterprise-defined task protocol, wherein the one or more dynamic inspection task checklists are associated with one or more respective AV subsystems;
cause the one or more dynamic inspection task checklists to be rendered via an interactive inspection interface such that one or more respective inspection tasks comprised in the one or more dynamic inspection task checklists are interactive;
initiate, based on information provided by the interactive inspection interface, an automated self-check protocol associated with the respective AV, wherein initializing the automated self-check protocol causes an in-vehicle control computer associated with the respective AV to execute one or more automated diagnostic procedures to ensure nominal function of one or more respective components of the one or more AV subsystems;
determine, based in part on the automated self-check protocol, whether the respective AV is certified to transition into an autonomous driving mode; and
in response to determining that the respective AV is certified to transition into the autonomous driving mode, deploy the respective AV to a next destination, wherein the next destination is determined based in part on the AV fleet data.

14. The apparatus of claim 13, wherein the first enterprise-defined task protocol is based on a first configuration of inspection task data objects corresponding to one or more respective inspection tasks associated with the one or more AV subsystems.

15. The apparatus of claim 13, wherein the computer program code instructions are further configured to cause the apparatus to:
generate one or more dynamic inspection task checklists for one or more respective AVs based on a second enterprise-defined task protocol, wherein the second enterprise-defined task protocol is based on a second configuration of inspection task data objects corresponding to one or more respective inspection tasks associated with the one or more AV subsystems.

16. The apparatus of claim 13, wherein the computer program code instructions are further configured to cause the apparatus to:
generate, based on at least one completed dynamic inspection task checklist of the one or more dynamic inspection task checklists, one or more interactive post-inspection reports, wherein the one or more interactive post-inspection reports describes a passing or a failure of the one or more respective AV subsystems associated with the respective AV.

17. The apparatus of claim 16, wherein the computer program code instructions are further configured to cause the apparatus to:
generate, based on the one or more interactive post-inspection reports, one or more post-inspection audit reports associated with the respective AV, wherein the one or more post-inspection audit reports describe compliance of the respective AV to one or more vehicle safety and regulatory standards.

18. The apparatus of claim 13, wherein the computer program code instructions are further configured to cause the apparatus to:
in response to determining the respective AV is not certified to transition into the autonomous driving mode:
transmit, to the operational server system, a suspension signal associated with the respective AV, wherein the suspension signal comprises an indication of one or more critical failures associated with the one or more respective AV subsystems; and
transmit, to the in-vehicle control computer associated with the respective AV, a hard-stop command such that the respective AV can no longer operate in the autonomous driving mode until the one or more critical failures have been corrected.

19. The apparatus of claim 13, wherein the computer program code instructions are further configured to cause the apparatus to:
capture image data associated with the one or more respective inspection tasks comprised in the one or more dynamic inspection task checklists.

20. The apparatus of claim 13, wherein the one or more dynamic inspection task checklists are generated based in part on one or more portions of AV fleet data, and wherein the one or more portions of AV fleet data comprises data related to at least one of AV mission data, AV location data, AV identification data, AV logistics data, AV payload data, AV health data, or AV safety compliance data.
